(19) United States
(12) Patent Application Publication
(10) Pub. No.: US 2024/0168992 A1
(43) Pub. Date: May 23, 2024

(54) IMAGE RETRIEVAL METHOD AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Xiujun SHU, Shenzhen (CN); Wei WEN, Shenzhen (CN); Ruizhi QIAO, Shenzhen (CN)

(21) Appl. No.: 18/421,239

(22) Filed: Jan. 24, 2024

Related U.S. Application Data
(63) Continuation of application No. PCT/CN2023/107962, filed on Jul. 18, 2023.

(30) Foreign Application Priority Data
Sep. 7, 2022 (CN) 202211089620.8

(51) Int. Cl. G06F 16/583; G06F 16/532; G06F 16/55; G06V 10/44; G06V 10/74

(52) U.S. Cl. CPC G06F 16/583; G06F 16/532; G06F 16/55; G06V 10/44; G06V 10/761

(57) ABSTRACT

An image retrieval method includes obtaining query data and a candidate image set including candidate images, performing feature extraction on the query data based on a target model to obtain first features of the query data, performing feature extraction on the candidate images based on the target model to obtain second features of the candidate images after the candidate images are aligned with the query data, determining similarities each between the candidate images and the query data in one modality according to the first features and the second features, determining result image sets corresponding to query data combinations from the candidate image set and including the query data in at least one modality according to the similarities, and merging the result image sets to obtain an image retrieval result.

### CROSS-REFERENCE TO RELATED APPLICATIONS

This application is a continuation of International Application No. PCT/CN2023/107962, filed on Jul. 18, 2023, which is based on and claims priority to Chinese Patent Application No. 202211089620.8, filed on Sep. 7, 2022, which are incorporated herein by reference in their entirety.

### FIELD OF THE TECHNOLOGY

This application relates to the field of artificial intelligence technologies, and in particular, to an image retrieval method and apparatus, an electronic device, and a storage medium.

### BACKGROUND OF THE DISCLOSURE

With the rapid development of Internet technologies, image retrieval is widely applied to a plurality of scenarios. In the related art, image retrieval is generally performed based on inputted to-be-retrieved data. The to-be-retrieved data is generally an image, that is, such an image retrieval manner is essentially image searching based on images. Specifically, an image similar to an inputted search image is retrieved from an image database. However, the image retrieval method cannot be generalized for other types of to-be-retrieved data, and image retrieval accuracy needs to be improved.

### SUMMARY

In accordance with the disclosure, there is provided an image retrieval method performed by an electronic device and including obtaining a candidate image set and query data in a plurality of modalities where the candidate image set includes a plurality of candidate images, performing feature extraction on the query data based on a target model to obtain a plurality of first features of the query data, performing feature extraction on the candidate images based on the target model to obtain a plurality of second features of the candidate images each being obtained by feature extraction after the candidate images are aligned with the query data in one of the modalities, determining a plurality of similarities each between the candidate images and the query data in one of the modalities according to the first features and the second features, determining result image sets corresponding to a plurality of query data combinations from the candidate image set according to the similarities where the query data combinations include the query data in at least one of the modalities, and merging the result image sets to obtain an image retrieval result.

Also in accordance with the disclosure, there is provided an electronic device including one or more processors and one or more memories storing at least one computer program that, when executed by the one or more processors, causes the one or more processors to obtain a candidate image set and query data in a plurality of modalities where the candidate image set includes a plurality of candidate images, perform feature extraction on the query data based on a target model to obtain a plurality of first features of the query data, perform feature extraction on the candidate images based on the target model to obtain a plurality of second features of the candidate images each being obtained by feature extraction after the candidate images are aligned with the query data in one of the modalities, determine a plurality of similarities each between the candidate images and the query data in one of the modalities according to the first features and the second features, determine result image sets corresponding to a plurality of query data combinations from the candidate image set according to the similarities where the query data combinations include the query data in at least one of the modalities, and merge the result image sets to obtain an image retrieval result.

Also in accordance with the disclosure, there is provided a non-transitory computer-readable storage medium storing at least one computer program that, when executed by one or more processors, causes the one or more processors to obtain a candidate image set and query data in a plurality of modalities where the candidate image set includes a plurality of candidate images, perform feature extraction on the query data based on a target model to obtain a plurality of first features of the query data, perform feature extraction on the candidate images based on the target model to obtain a plurality of second features of the candidate images each being obtained by feature extraction after the candidate images are aligned with the query data in one of the modalities, determine a plurality of similarities each between the candidate images and the query data in one of the modalities according to the first features and the second features, determine result image sets corresponding to a plurality of query data combinations from the candidate image set according to the similarities where the query data combinations include the query data in at least one of the modalities, and merge the result image sets to obtain an image retrieval result.

### BRIEF DESCRIPTION OF THE DRAWINGS

The accompanying drawings are used to provide further understanding of the technical solutions of this application, and constitute a part of the specification, which are used to explain the technical solutions of this application in combination with the embodiments of this application, and do not constitute a limitation to the technical solutions of this application.

FIG. 1 is a schematic diagram of an optional implementation environment according to an embodiment of this application.

FIG. 2 is an optional schematic flowchart of an image retrieval method according to an embodiment of this application.

FIG. 3 is an optional schematic structural diagram of a target model according to an embodiment of this application.

FIG. 4 is an optional schematic flowchart of obtaining an image retrieval result based on a plurality of to-be-retrieved data combinations according to an embodiment of this application.

FIG. 5 is another optional schematic structural diagram of a target model according to an embodiment of this application.

FIG. 6 is an optional schematic diagram of a training process of a target model according to an embodiment of this application.

FIG. 7 is an optional schematic flowchart of expanding a training sample according to an embodiment of this application.

FIG. 8 is an optional schematic diagram of an overall architecture of a target model according to an embodiment of this application.

FIG. 9 is another optional schematic diagram of an overall architecture of a target model according to an embodiment of this application.

FIG. 10 is still another optional schematic diagram of an overall architecture of a target model according to an embodiment of this application.

FIG. 11 is yet another optional schematic diagram of an overall architecture of a target model according to an embodiment of this application.

FIG. 12 is a schematic flowchart of performing image retrieval by using a search engine according to an embodiment of this application.

FIG. 13 is a schematic flowchart of performing image retrieval on a photo application according to an embodiment of this application.

FIG. 14 is an optional schematic structural diagram of an image retrieval apparatus according to an embodiment of this application.

FIG. 15 is a block diagram of a structure of a part of a terminal according to an embodiment of this application.

FIG. 16 is a block diagram of a structure of a part of a server according to an embodiment of this application.

### DESCRIPTION OF EMBODIMENTS

To make the objectives, technical solutions, and advantages of this application clearer, the following further describes this application in detail with reference to the accompanying drawings and the embodiments. It is to be understood that specific embodiments described herein are merely used to describe this application, but are not intended to limit this application.

In specific implementations of this application, permission or consent of a target object may be first obtained when related processing needs to be performed according to data related to a target object characteristic, for example, target object attribute information, an attribute information set, or the like. In addition, acquisition, use, and processing of the data comply with the relevant laws and standards of the relevant countries and regions. The target object may be a user. In addition, in the embodiments of this application, when the target object attribute information needs to be obtained, individual permission or consent of the target object may be obtained in a manner of displaying a pop-up window, jumping to a confirmation page, or the like. After it is determined that individual permission or consent of the target object is obtained, necessary target object-related data for normal operation in the embodiments of this application is obtained.

In the related art, image retrieval is generally performed based on inputted to-be-retrieved data. The to-be-retrieved data is generally an image, that is, such an image retrieval manner is essentially image searching based on images. Specifically, an image similar to an inputted search image may be retrieved from an image database. However, the image retrieval method cannot be generalized for other types of to-be-retrieved data, and image retrieval accuracy needs to be improved.

In view of this, the embodiments of this application provide an image retrieval method and apparatus, an electronic device, and a storage medium, which can improve image retrieval accuracy.

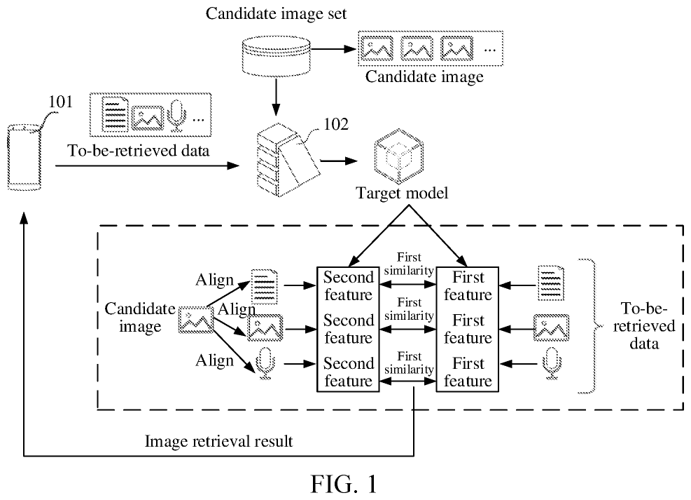

Refer to FIG. 1. FIG. 1 is a schematic diagram of an optional implementation environment according to an embodiment of this application. The implementation environment includes a terminal 101 and a server 102. The terminal 101 and the server 102 are connected to each other through a communication network.

The server 102 may be an independent physical server, or may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. In addition, the server 102 may further be a node server in a blockchain network.

The terminal 101 may be a smartphone, a tablet computer, a notebook computer, a desktop computer, a smart speaker, a smartwatch, an in-vehicle terminal, or the like, but is not limited thereto. The terminal 101 and the server 102 may be directly or indirectly connected in a wired or wireless communication manner. This is not limited in this embodiment of this application.

For example, the terminal 101 may send to-be-retrieved data in a plurality of modalities to the server 102. The server 102 receives the to-be-retrieved data and obtains a pre-stored candidate image set, performs feature extraction on the to-be-retrieved data based on a target model to obtain a first feature of the to-be-retrieved data, performs feature extraction on a candidate image based on the target model for a plurality of times to obtain a second feature of the candidate image obtained after the candidate image is aligned with to-be-retrieved data in each modality, determines a first similarity between the candidate image and to-be-retrieved data in each modality according to the first feature and the second feature, determines result image sets corresponding to a plurality of to-be-retrieved data combinations from the candidate image set according to the first similarity, merges a plurality of result image sets to obtain an image retrieval result, and sends the image retrieval result to the terminal 101. The terminal 101 displays the image retrieval result. The server 102 performs feature extraction on the to-be-retrieved data through the target model to obtain a first feature of the to-be-retrieved data, and then performs feature extraction on the candidate image through the same target model for a plurality of times to obtain a second feature of the candidate image obtained after the candidate image is aligned with to-be-retrieved data in each modality, which can improve image retrieval accuracy by using to-be-retrieved data in a plurality of modalities, and unify feature frameworks of the to-be-retrieved data in the plurality of modalities and the candidate image, thereby improving feature space consistency between the first feature and the second feature. Moreover, the server determines the first feature and the second feature by using the same target model, which can reduce a quantity of parameters of the target model, and reduce memory overheads for deploying the target model. In addition, only the same target model needs to be trained in a training stage, which improves model training efficiency. Based on the above, the server determines a first similarity between the candidate image and to-be-retrieved data in each modality according to the first feature and the second feature, determines result image sets corresponding to a plurality of to-be-retrieved data combinations from the candidate image set according to the first similarity, and merges a plurality of result image sets to obtain an image retrieval result. In this way, there is no need to compare the to-be-retrieved data and the candidate images in a one-to-one manner, so that image retrieval efficiency is effectively improved. In addition, the image retrieval result is obtained based on the result image sets corresponding to the plurality of to-be-retrieved data combinations, which can effectively improve image retrieval accuracy.

The method provided in the embodiments of this application is applicable to various technical fields, including but not limited to technical fields such as the cloud technology, artificial intelligence, and the like.

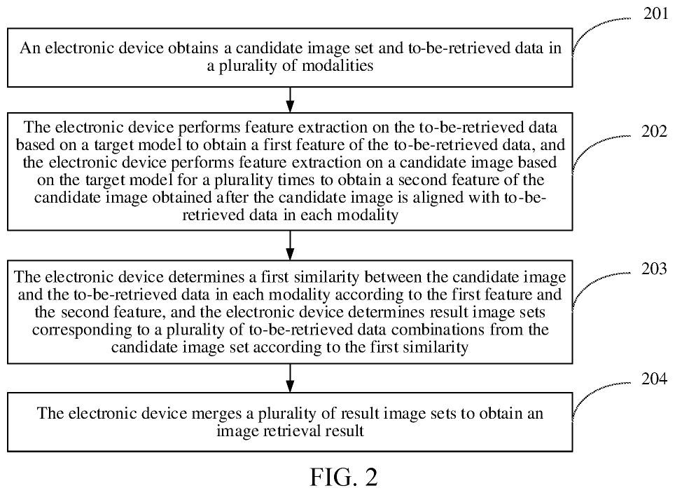

Refer to FIG. 2. FIG. 2 is an optional schematic flowchart of an image retrieval method according to an embodiment of this application. The image retrieval method may be performed by a server, or may be performed by a terminal, or may be jointly performed by a server and a terminal through cooperation. The image retrieval method includes but is not limited to step 201 to step 204 below.

Step 201: An electronic device obtains a candidate image set and to-be-retrieved data in a plurality of modalities.

The candidate image set includes a plurality of candidate images, the candidate image is an image in a retrieval database. An image retrieval result is generated based on the candidate image set. The to-be-retrieved data is query data during image retrieval. The modality is configured for indicating an existence form of the to-be-retrieved data. The modality may be an image modality, a text modality, a voice modality, or the like. The to-be-retrieved data in the image modality is a to-be-retrieved image (“query image”), the to-be-retrieved data in the text modality is a to-be-retrieved text (“query text”), and the to-be-retrieved data in the voice modality is to-be-retrieved voice (“query voice”).

In a possible implementation, the to-be-retrieved data in the plurality of modalities may include the to-be-retrieved image and the to-be-retrieved text, or the to-be-retrieved data in the plurality of modalities may include the to-be-retrieved image and the to-be-retrieved voice, or the to-be-retrieved data in the plurality of modalities may include the to-be-retrieved text and the to-be-retrieved voice, or the to-be-retrieved data in the plurality of modalities may include the to-be-retrieved image, the to-be-retrieved text, and the to-be-retrieved voice.

The to-be-retrieved data in the plurality of modalities may be independent of each other, the to-be-retrieved data in different modalities may be associated with each other or may not be associated. For example, the to-be-retrieved data in the plurality of modalities includes the to-be-retrieved image and the to-be-retrieved text. The to-be-retrieved image may be an image including three peonies, and the to-be-retrieved text may be “three peonies”. In this case, the to-be-retrieved image is associated with the to-be-retrieved text. In another example, the to-be-retrieved image may be an image including three peonies, and the to-be-retrieved text may be “three cars”. In this case, the to-be-retrieved image is not associated with the to-be-retrieved text.

Step 202: The electronic device performs feature extraction on the to-be-retrieved data based on a target model, to obtain a first feature of the to-be-retrieved data; and the electronic device performs feature extraction on the candidate image based on the target model for a plurality times, to obtain a second feature of the candidate image obtained after the candidate image is aligned with to-be-retrieved data in each modality.

In a possible implementation, feature extraction is to map the to-be-retrieved data to a high-dimensional feature space. That feature extraction is performed on the to-be-retrieved data based on a target model may be to perform feature extraction on the to-be-retrieved data in each modality based on the target model. Correspondingly, different feature extraction units may be configured for the target model, to perform feature extraction on the to-be-retrieved data in each modality. For example, when the to-be-retrieved data in the plurality of modalities includes the to-be-retrieved image and the to-be-retrieved text, the target model includes an image feature extraction unit and a text feature extraction unit, where the image feature extraction unit is configured to perform feature extraction on the to-be-retrieved image, and the text feature extraction unit is configured to perform feature extraction on the to-be-retrieved text; when the to-be-retrieved data in the plurality of modalities includes the to-be-retrieved image and the to-be-retrieved voice, the target model includes an image feature extraction unit and a voice feature extraction unit, where the voice feature extraction unit is configured to perform feature extraction on the to-be-retrieved voice; when the to-be-retrieved data in the plurality of modalities includes the to-be-retrieved text and the to-be-retrieved voice, the target model includes a text feature extraction unit and a voice feature extraction unit; or when the to-be-retrieved data in the plurality of modalities includes the to-be-retrieved image, the to-be-retrieved text, and the to-be-retrieved voice, the target model includes an image feature extraction unit, a text feature extraction unit, and a voice feature extraction unit.

In a possible implementation, when feature extraction is performed on the to-be-retrieved data based on the target model to obtain the first feature of the to-be-retrieved data, to be specific, the to-be-retrieved data is converted into a retrieval embedding vector, the retrieval embedding vector is inputted into the target model, and feature extraction is performed on the to-be-retrieved data based on the target model, to obtain the first feature of the to-be-retrieved data. The retrieval embedding vector is configured for representing an initial feature (which is a feature before the target model performs feature extraction) of the to-be-retrieved data. The to-be-retrieved data in different modalities is converted into retrieval embedding vectors in a same vector format, which facilitates unification of representation of the to-be-retrieved data in the plurality of modalities in a same model framework.

Specifically, the retrieval embedding vector may include an information embedding vector and a type embedding vector concatenated to each other. The information embedding vector is configured for representing an information feature included in the to-be-retrieved data. For example, when the to-be-retrieved data is a to-be-retrieved image, the information embedding vector is configured for representing image information of the to-be-retrieved image; when the to-be-retrieved data is a to-be-retrieved text, the information embedding vector is configured for representing text information of the to-be-retrieved image; and when the to-be-retrieved data is to-be-retrieved voice, the information embedding vector is configured for representing voice information of the to-be-retrieved image. The type embedding vector is configured for representing a modality type feature of the to-be-retrieved data. For example, when the to-be-retrieved data is a to-be-retrieved image, the type embedding vector is configured for indicating that the to-be-retrieved data is in an image modality; when the to-be-retrieved data is a to-be-retrieved text, the type embedding vector is configured for indicating that the to-be-retrieved data in a text modality; and when the to-be-retrieved data is to-be-retrieved voice, the type embedding vector is configured for indicating that the to-be-retrieved data is in a voice modality. Based on the above, the retrieval embedding vector may be represented as:

X=f_{inf}+f_{typ}

X represents the retrieval embedding vector, f_{inf} represents the information embedding vector, and f_{typ} represents the type embedding vector.

Since the retrieval embedding vector includes the information embedding vector and the type embedding vector concatenated to each other, the image information of the to-be-retrieved image may be represented based on the information embedding vector, and the modality type feature of the to-be-retrieved data may be represented based on the type embedding vector. When feature extraction is subsequently performed on the to-be-retrieved data based on the target model, the target model may determine a modality of current to-be-retrieved data according to the type embedding vector, so that a corresponding feature extraction unit is invoked to perform feature extraction on the to-be-retrieved data, to enable the target model to distinguish the to-be-retrieved data in the plurality of modalities, thereby facilitating unification of representation of the to-be-retrieved data in the plurality of modalities in the same model framework.

In a possible implementation, the candidate image is aligned with the to-be-retrieved data in each modality, that is, the candidate image and the to-be-retrieved data in each modality are mapped to a same high-dimensional feature space, that is, the first feature and the second feature are aligned with each other. For example, if the to-be-retrieved data in the plurality of modalities includes the to-be-retrieved image and the to-be-retrieved text, the candidate image and the to-be-retrieved image are aligned, and the candidate image and the to-be-retrieved text are aligned. Correspondingly, a quantity of obtained second features is equal to a quantity of modalities of the to-be-retrieved data, that is, a second feature of the candidate image obtained after the candidate image is aligned with the to-be-retrieved image is obtained, and a second feature of the candidate image obtained after the candidate image is aligned with the to-be-retrieved text. It may be understood that, if the to-be-retrieved data in the plurality of modalities includes the to-be-retrieved image, the to-be-retrieved text, and the to-be-retrieved voice, the candidate image and the to-be-retrieved voice are also aligned, to obtain a second feature of the candidate image obtained after the candidate image is aligned with the to-be-retrieved voice.

Correspondingly, the target model may include different modality alignment units to perform feature extraction on the candidate image, to align the candidate image to to-be-retrieved data in a corresponding modality. For example, when the to-be-retrieved data includes the to-be-retrieved image and the to-be-retrieved text, the target model includes an image modality alignment unit and a text modality alignment unit, where the image modality alignment unit is configured to align the candidate image with the to-be-retrieved image, and the text modality alignment unit is configured to align the candidate image with the to-be-retrieved text; when the to-be-retrieved data in the plurality of modalities includes the to-be-retrieved image and the to-be-retrieved voice, the target model includes an image modality alignment unit and a voice modality alignment unit, where the voice modality alignment unit is configured to align the candidate image with the to-be-retrieved voice; when the to-be-retrieved data in the plurality of modalities includes the to-be-retrieved text and the to-be-retrieved voice, the target model includes a text modality alignment unit and a voice modality alignment unit; or when the to-be-retrieved data in the plurality of modalities includes the to-be-retrieved image, the to-be-retrieved text, and the to-be-retrieved voice, the target model includes an image modality alignment unit, a text modality alignment unit, and a voice modality alignment unit.

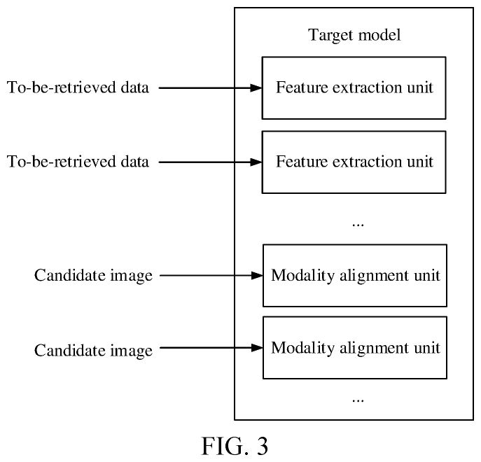

Specifically, referring to FIG. 3, FIG. 3 is an optional schematic structural diagram of a target model according to an embodiment of this application. The target model includes a plurality of feature extraction units and a plurality of modality alignment units. Each feature extraction unit is configured to perform feature extraction on to-be-retrieved data in a corresponding modality, and each modality alignment unit is configured to perform feature extraction on the candidate image, to enable the candidate image to be aligned with to-be-retrieved data in a corresponding modality. Parameters between the feature extraction units may be different, and parameters between the modality alignment units may be different. The plurality of feature extraction units and the plurality of modality alignment units are configured in the target model. Feature extraction is performed on the to-be-retrieved data through the target model to obtain a first feature of the to-be-retrieved data, and then feature extraction is performed on the candidate image through the same target model for a plurality of times to obtain a second feature of the candidate image obtained after the candidate image is aligned with to-be-retrieved data in each modality, which can improve image retrieval accuracy by using to-be-retrieved data in a plurality of modalities, and unify feature frameworks of the to-be-retrieved data in the plurality of modalities and the candidate image, thereby improving feature space consistency between the first feature and the second feature. Moreover, the server determines the first feature and the second feature by using the same target model, which can reduce a quantity of parameters of the target model, and reduce memory overheads for deploying the target model. In addition, only the same target model needs to be trained in a training stage, which improves model training efficiency.

In a possible implementation, since the candidate image is data in the image modality, the image feature extraction unit may be used as an image modality alignment unit. In other words, when the to-be-retrieved data in the plurality of modalities includes to-be-retrieved data in the image modality, a first feature of the to-be-retrieved image may be obtained by using the image feature extraction unit. In addition, the second feature of the candidate image may be obtained by using the image feature extraction unit. In this way, a reuse effect of the image feature extraction unit is achieved, and a structure of the target model is simplified.

It may be understood that, an image modality alignment unit may also be additionally configured, to obtain the second feature of the candidate image. This is not limited in this embodiment of this application.

Therefore, when the to-be-retrieved data in the plurality of modalities includes the to-be-retrieved text and the to-be-retrieved image, and feature extraction is performed on the candidate image based on the target model for a plurality of times to obtain the second feature of the candidate image obtained after the candidate image is aligned with the to-be-retrieved data, to be specific, feature extraction may be performed on candidate image based on the text modality alignment unit, to obtain a second feature of the candidate image obtained after the candidate image is aligned with the to-be-retrieved text; and feature extraction is performed on the candidate image based on the image feature extraction unit to obtain an image feature of the candidate image, and the image feature is used as a second feature of the candidate image obtained after the candidate image is aligned with the to-be-retrieved image, so that the reuse effect of the image feature extraction unit is achieved, and the structure of the target model is simplified.

The foregoing manner of reusing the image feature extraction unit may also be adopted when the to-be-retrieved data in the plurality of modalities includes the to-be-retrieved voice and the to-be-retrieved image, or when the to-be-retrieved data in the plurality of modalities includes the to-be-retrieved text, the to-be-retrieved voice, and the to-be-retrieved image. Details are not described herein again.

Step 203: The electronic device determines a first similarity between the candidate image and the to-be-retrieved data in each modality according to the first feature and the second feature, and the electronic device determines result image sets corresponding to a plurality of to-be-retrieved data combinations from the candidate image set according to the first similarity.

The first similarity between the candidate image and the to-be-retrieved data in each modality is determined according to the first feature and the second feature, that is, a quantity of first similarities is equal to the quantity of modalities of the to-be-retrieved data. For example, when the to-be-retrieved data in the plurality of modalities includes the to-be-retrieved image and the to-be-retrieved text, a first similarity between the to-be-retrieved image and the candidate image is determined according to the first feature of the to-be-retrieved image and the second feature of the candidate image obtained after the candidate image is aligned with the to-be-retrieved image, and a first similarity between the to-be-retrieved text and the candidate image is determined according to a first feature of the to-be-retrieved text and the second feature of the candidate image obtained after the candidate image is aligned with the to-be-retrieved text; or when the to-be-retrieved data in the plurality of modalities includes the to-be-retrieved text, the to-be-retrieved image, and the to-be-retrieved voice, a first similarity between the to-be-retrieved image and the candidate image is determined according to the first feature of the to-be-retrieved image and the second feature of the candidate image obtained after the candidate image is aligned with the to-be-retrieved image, a first similarity between the to-be-retrieved text and the candidate image is determined according to a first feature of the to-be-retrieved text and the second feature of the candidate image obtained after the candidate image is aligned with the to-be-retrieved text, and a first similarity between the to-be-retrieved voice and the candidate image according to a first feature of the to-be-retrieved voice and the second feature of the candidate image obtained after the candidate image is aligned with the to-be-retrieved voice.

The to-be-retrieved data combination includes to-be-retrieved data in at least one modality. In other words, the to-be-retrieved data combination may include to-be-retrieved data in one modality (that is, a first data combination), and may further include to-be-retrieved data in a plurality of modalities (that is, a second data combination). For example, the first data combination may include the to-be-retrieved image, or may include the to-be-retrieved text, or may include the to-be-retrieved voice. The second data combination may include the to-be-retrieved image and the to-be-retrieved text, or may include the to-be-retrieved image and the to-be-retrieved voice, or may include the to-be-retrieved text and the to-be-retrieved voice, or may include the to-be-retrieved image, the to-be-retrieved text, and the to-be-retrieved voice, or the like.

In a possible implementation, the first similarities may be a distance matrix of Euclidean distances, a similarity matrix of cosine similarities, a distance matrix of Chebyshev distances, or the like. This is not limited in this embodiment of this application.

Since different to-be-retrieved data combinations correspond to one first similarity or a plurality of different first similarities, the result image sets corresponding to the plurality of to-be-retrieved data combinations may be determined from the candidate image set according to the first similarity.

For example, when the to-be-retrieved data in the plurality of modalities includes the to-be-retrieved image and the to-be-retrieved text, the plurality of to-be-retrieved data combinations may be the to-be-retrieved image and the to-be-retrieved text. Correspondingly, the result image sets corresponding to the plurality of to-be-retrieved data combinations are a result image set corresponding to the to-be-retrieved image and a result image set corresponding to the to-be-retrieved text. In this case, each to-be-retrieved data combination is the first data combination. Therefore, an image retrieval result may be subsequently obtained with reference to the result image set selected based on the to-be-retrieved data in the plurality of modalities, so that image retrieval accuracy can be improved.

In addition, when the to-be-retrieved data in the plurality of modalities includes the to-be-retrieved image and the to-be-retrieved text, a manner of combining the first data combination and the second data combination may also be used, that is, different to-be-retrieved data combinations may be the to-be-retrieved image, the to-be-retrieved text, and a combination of the to-be-retrieved image and the to-be-retrieved text. Correspondingly, result image sets corresponding to different to-be-retrieved data combinations are a result image set corresponding to the to-be-retrieved image, a result image set corresponding to the to-be-retrieved text, and a result image set corresponding to the combination of the to-be-retrieved image and the to-be-retrieved text. In this way, on the basis of obtaining the image retrieval result by using the to-be-retrieved data in each modality, a combination of the to-be-retrieved data in the plurality of modalities is further introduced to expand the image retrieval result, to further improve image retrieval accuracy.

In a possible implementation, if the image retrieval result is obtained in the manner of combining the first data combination and the second data combination, when the result image sets corresponding to the plurality of to-be-retrieved data combinations are determined from the candidate image set according to the first similarity, to be specific, a result image set corresponding to the first data combination may be determined from the candidate image set according to a first similarity corresponding to the to-be-retrieved data in one modality; and first similarities corresponding to the to-be-retrieved data in the plurality of modalities are fused to obtain a target similarity, and a result image set corresponding to the second data combination is determined from the candidate image set according to the target similarity.

Specifically, the result image set corresponding to the first data combination is a result image set with respective to the to-be-retrieved data in the plurality of modalities, and the result image set corresponding to the second data combination is a result image set corresponding to the combination of the to-be-retrieved data in the plurality of modalities. For example, when the to-be-retrieved data includes the to-be-retrieved image and the to-be-retrieved text, the result image set corresponding to the first data combination is a result image set corresponding to the to-be-retrieved image and a result image set corresponding to the to-be-retrieved text. Based on this, a first similarity corresponding to the to-be-retrieved image and a first similarity corresponding to the to-be-retrieved text may be fused to obtain a target similarity, to implement image retrieval in a manner of combining the to-be-retrieved image and the to-be-retrieved text. A fusion manner may be weighting or may be multiplying a plurality of similarities.

In a possible implementation, the result image set may directly include target images that are in the candidate image set and that match the to-be-retrieved data combinations. In addition, a quantity of target images in the result image set may be preset. When there are a plurality of target images, the target images determined from the candidate image set may further be sorted, for example, may be sorted in descending order of first similarities, to make the result image set clearer.

Step 204: The electronic device merges a plurality of result image sets to obtain an image retrieval result.

Since different to-be-retrieved data combinations correspond to respective result image sets, the plurality of result image sets may be merged to obtain a final image retrieval result. To be specific, deduplication processing is performed on the result image sets to output a final image retrieval result, or different result image sets may be directly outputted in parallel as a final image retrieval result.

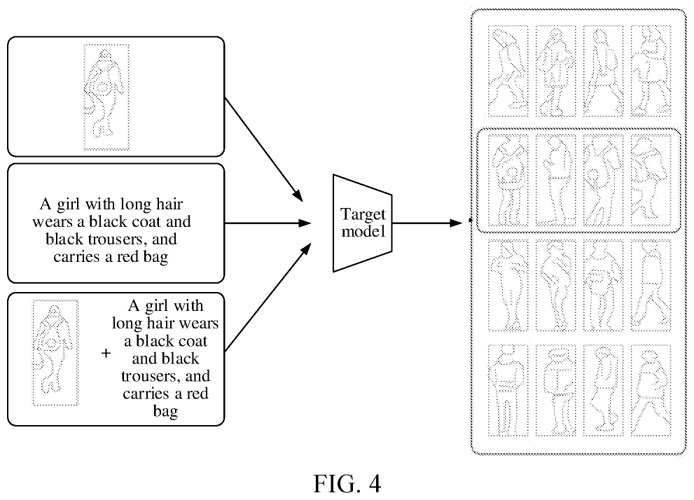

For example, referring to FIG. 4, FIG. 4 is an optional schematic flowchart of obtaining an image retrieval result based on a plurality of to-be-retrieved data combinations according to an embodiment of this application. For example, the to-be-retrieved data in the plurality of modalities includes the to-be-retrieved image and the to-be-retrieved text. The to-be-retrieved image is an image of a girl carrying a bag, and the to-be-retrieved text is “a girl with long hair wears a black coat and black trousers, and carries a red bag”. The image of a girl carrying a bag is a to-be-retrieved data combination, the text “a girl with long hair wears a black coat and black trousers, and carries a red bag” is a to-be-retrieved data combination, and a combination of the image of a girl carrying a bag and the text “a girl with long hair wears a black coat and black trousers, and carries a red bag” is a to-be-retrieved data combination. Result image sets corresponding to different to-be-retrieved data combinations are merged to obtain an image retrieval result.

In a possible implementation, the to-be-retrieved data and the candidate image may be retrieved in a one-to-one manner to obtain an image retrieval result. One-to-one retrieval is to input the to-be-retrieved data and each candidate image into a retrieval model as a data pair. The retrieval model outputs a matching probability between the to-be-retrieved data and the candidate image. Since there are a plurality of candidate images, one-to-one retrieval needs to be performed in a pairwise traversal manner, which consumes more retrieval resources. In this embodiment of this application, a first similarity between the candidate image and to-be-retrieved data in each modality is determined according to the first feature and the second feature, result image sets corresponding to a plurality of to-be-retrieved data combinations is determined from the candidate image set according to the first similarity, and a plurality of result image sets are merged to obtain an image retrieval result. In this way, there is no need to retrieve the to-be-retrieved data and the candidate images in a one-to-one manner, so that image retrieval efficiency is effectively improved. In addition, the image retrieval result is obtained based on the result image sets corresponding to the plurality of to-be-retrieved data combinations, which can effectively improve image retrieval accuracy.

In a possible implementation, when the to-be-retrieved data is converted into a retrieval embedding vector, to be specific, the to-be-retrieved data may be segmented to obtain a plurality of to-be-retrieved data blocks, and feature mapping is performed on the plurality of to-be-retrieved data blocks to obtain a first embedding vector; location information of each to-be-retrieved data block in the to-be-retrieved data is determined, and feature mapping is performed on a plurality of pieces of location information to obtain a second embedding vector; feature mapping is performed on a modality corresponding to the to-be-retrieved data, to obtain a third embedding vector; and the first embedding vector, the second embedding vector, and the third embedding vector are concatenated, to obtain the retrieval embedding vector.

A vector obtained by concatenating the first embedding vector and the second embedding vector is equivalent to the information embedding vector. The first embedding vector is obtained by segmenting the to-be-retrieved data, and the second embedding vector is obtained according to the location information of each to-be-retrieved data block in the to-be-retrieved data, to enable the information embedding vector to carry more information about the to-be-retrieved data, thereby improving accuracy of the information embedding vector. The third embedding vector is equivalent to the type embedding vector and is configured for the target model to determine a modality of current to-be-retrieved data according to the type embedding vector.

For the to-be-retrieved text, the to-be-retrieved data is segmented to obtain a plurality of to-be-retrieved data blocks. To be specific, word segmentation may be performed on the to-be-retrieved text to obtain a plurality of text words, and a start flag and an end flag of the to-be-retrieved text are added and then encoded through a text encoder, which may be specifically represented as follows:

t={[cls],t₁, . . . t_{M},[sep]}

t represents a result obtained through encoding by the text encoder, [cls] represents the start flag, [Sep] represents the end flag, and t₁, . . . t_{M} represent the text words. M is a positive integer.

The result obtained through encoding by the text encoder may be mapped to a symbol embedding vector f^{t}=[f_{cls}^{t}, f₁^{t} . . . f_{M}^{t}, fₛₑₚ^{t}] in a pre-trained wording embedding manner, to obtain a first embedding vector. Location information of each text word in the to-be-retrieved text is determined, and feature mapping is performed on the location information of each text word in the to-be-retrieved text, to obtain a second embedding vector. Then, feature mapping is performed on a text modality to obtain a third embedding vector. The first embedding vector, the second embedding vector, and the third embedding vector that correspond to the to-be-retrieved text are concatenated, so that a retrieval embedding vector corresponding to the to-be-retrieved text is obtained, which may be specifically represented as follows:

x^{t}=[f_{cls}^{t},f₁^{t}. . . f_{M}^{t},fₛₑₚ^{t}]fₚₒₛ^{t}+f_{typ}^{t}

X^{t} represents the retrieval embedding vector corresponding to the to-be-retrieved text, [f_{cls}^{t}, f₁^{t} . . . f_{M}^{t}, fₛₑₚ^{t}] represent the first embedding vector corresponding to the to-be-retrieved text, a s represents the second embedding vector corresponding to the to-be-retrieved text, and f_{typ}^{t} represents the third embedding vector corresponding to the to-be-retrieved text.

For the to-be-retrieved image, the to-be-retrieved data is segmented to obtain a plurality of to-be-retrieved data blocks. To be specific, image segmentation may be performed on the to-be-retrieved image to obtain a plurality of image blocks, and a start flag of the to-be-retrieved image is added and then encoded through an image encoder, which may be specifically represented as follows:

v={[cls],v₁, . . . v_{N}}

v represents a result obtained through encoding by the image encoder, [cls] represents the start flag, and v₁, . . . v_{N} represent the image blocks. N is a positive integer.

Feature mapping is performed on the result obtained through encoding by the image encoder in a manner similar to that in the text modality, to obtain a first embedding vector. Location information of each image block in the to-be-retrieved image is determined, and feature mapping is performed on the location information of each image block in the to-be-retrieved image, to obtain a second embedding vector. Then, feature mapping is performed on an image modality to obtain a third embedding vector. The first embedding vector, the second embedding vector, and the third embedding vector that correspond to the to-be-retrieved image are concatenated, so that a retrieval embedding vector corresponding to the to-be-retrieved image is obtained, which may be specifically represented as follows:

x^{v}=[f_{cls}^{v},f₁^{v}. . . f_{N}^{v},fₛₑₚ^{v}]+fₚₒₛ^{v}+f_{typ}^{v}

x^{v} represents the retrieval embedding vector corresponding to the to-be-retrieved image, [f_{cls}^{v}, f₁^{v} . . . f_{N}^{v}, fₛₑₚ^{v}] represent the first embedding vector corresponding to the to-be-retrieved image, fₚₒₛ^{v} represents the second embedding vector corresponding to the to-be-retrieved image, and f_{typ}^{v} represents the third embedding vector corresponding to the to-be-retrieved image.

For the to-be-retrieved voice, the to-be-retrieved data is segmented to obtain a plurality of to-be-retrieved data blocks. To be specific, voice segmentation may be performed on the to-be-retrieved voice to obtain a plurality of voice frames, and a start flag and an end flag of the to-be-retrieved voice are added and then encoded through a voice encoder, which may be specifically represented as follows:

s={[cls],s₁, . . . s_{K},[sep]}

s represents a result obtained through encoding by the voice encoder, [cls] represents the start flag, [Sep] represents the end flag, and s₁, . . . s_{K} represent the voice frames. K is a positive integer.

Feature mapping is performed on the result obtained through encoding by the voice encoder in a manner similar to that in the text modality, to obtain a first embedding vector. Location information of each voice frame in the to-be-retrieved voice is determined, and feature mapping is performed on the location information of each voice frame in the to-be-retrieved voice, to obtain a second embedding vector. Then, feature mapping is performed on a voice modality to obtain a third embedding vector. The first embedding vector, the second embedding vector, and the third embedding vector that correspond to the to-be-retrieved voice are concatenated, so that a retrieval embedding vector corresponding to the to-be-retrieved voice is obtained, which may be specifically represented as follows:

X^{s}=[f_{cls}^{s},f₁^{s}. . . f_{K}^{s},fₛₑₚ^{s}]+fₚₒₛ^{s}+f_{typ}^{s}

X^{s} represents the retrieval embedding vector corresponding to the to-be-retrieved voice, [f_{cls}^{s}, f₁^{s} . . . f_{K}^{s}, fₛₑₚ^{s}] represent the first embedding vector corresponding to the to-be-retrieved voice, fₚₒₛ^{s} represents the second embedding vector corresponding to the to-be-retrieved voice, and f_{typ}^{s} represents the third embedding vector corresponding to the to-be-retrieved voice.

As can be seen, the retrieval embedding vectors of the to-be-retrieved data in different modalities have the same vector format, to facilitate unification of representation of the to-be-retrieved data in the plurality of modalities in the same model framework, so that the target model may perform feature extraction on the to-be-retrieved data in different modalities, thereby providing a basis for subsequently determining target images corresponding to different to-be-retrieved data combinations from a plurality of candidate images.

In a possible implementation, when feature mapping is performed on the result obtained through encoding by the text encoder, the result obtained through encoding by the image encoder, and the result obtained through encoding by the voice encoder, results obtained through different encoders may be mapped to different high-dimensional feature spaces, so that an obtained first embedding vector can better match a feature representation requirement of a corresponding modality, thereby improving accuracy and properness of the first embedding vector.

It may be understood that, since the candidate image is data in the image modality, when feature extraction is performed on the candidate image based on the target model, feature extraction may be performed on the candidate image with reference to the foregoing manner of obtaining the retrieval embedding vector corresponding to the to-be-retrieved image, to obtain an embedding vector corresponding to the candidate image, and then the embedding vector corresponding to the candidate image is inputted into the target model to perform feature extraction on the candidate image.

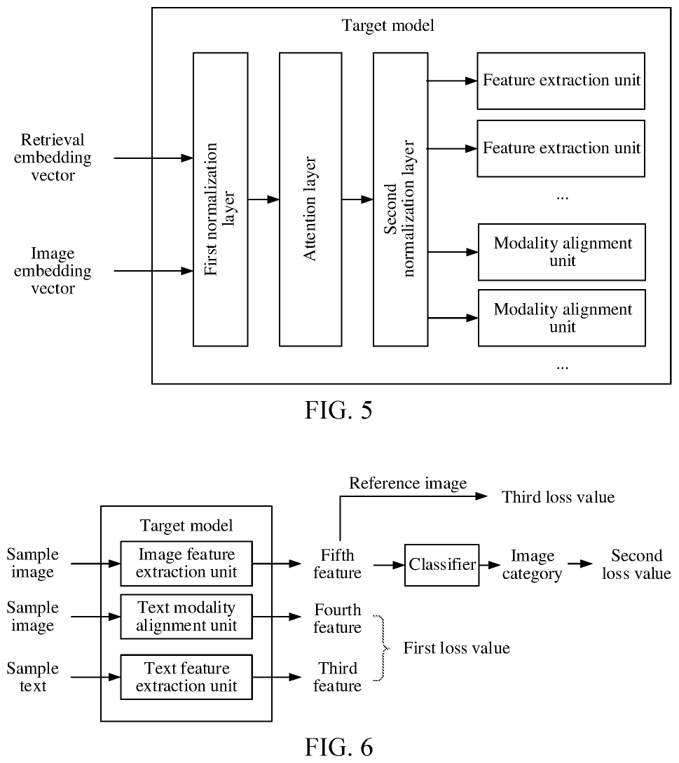

Refer to FIG. 5. FIG. 5 is another optional schematic structural diagram of a target model according to an embodiment of this application. The target model may include a first normalization layer, an attention layer, a second normalization layer, a plurality of feature extraction units, and a plurality of modality alignment unit. Based on a model structure shown in FIG. 5, when feature extraction is performed on the to-be-retrieved data based on the target model to obtain a first feature of the to-be-retrieved data, to be specific, normalization may be performed on the retrieval embedding vector to obtain a first normalized vector, attention feature extraction is performed on the first normalized vector to obtain an attention vector, and feature extraction is performed on the attention vector based on the target model to obtain the first feature of the to-be-retrieved data.

Normalization may be performed on the retrieval embedding vector through the first normalization layer, to achieve a data standardization effect of the retrieval embedding vector, thereby improving efficiency of processing the retrieval embedding vector by the target model. Attention feature extraction may be performed on the first normalized vector through the attention layer, to extract important information in the first normalized vector, so that the first feature of the to-be-retrieved data obtained by subsequently performing feature extraction on the attention vector based on the target model is more accurate.

In a possible implementation, attention feature extraction may be performed on the first normalized vector through the attention layer by using a multi-head attention mechanism. The first normalization layer, the attention layer, the second normalization layer, the plurality of feature extraction units, and the plurality of modality alignment units may form an entire processing module. A plurality of processing modules may be stacked in the target model, an input by a previous processing module is used as an input by a next processing module, and an output by a last processing module is a final first feature, thereby improving accuracy of the first feature.

In a possible implementation, after the attention vector is obtained, when feature mapping is performed on the attention vector based on the target model to obtain the first feature of the to-be-retrieved data, to be specific, the attention vector and the retrieval embedding vector are concatenated to obtain a concatenated vector; the concatenated vector is normalized to obtain a second normalized vector; feed forward feature mapping is performed on the second normalized vector based on the target model, to obtain a mapping vector; and the mapping vector and the concatenated vector are concatenated to obtain the first feature of the to-be-retrieved data.

That feed forward feature mapping is performed on the second normalized vector based on the target model to obtain the mapping vector is to perform feed forward feature mapping on the second normalized vector based a corresponding feature extraction unit to obtain the mapping vector. In this case, the feature extraction unit may include a feed forward mapping layer. The attention vector and the retrieval embedding vector are concatenated, to obtain the concatenated vector, so that the concatenated vector may carry original information of the retrieval embedding vector, thereby improving accuracy of the concatenated vector.

Normalization may be performed on the concatenated vector through the second normalization layer, to achieve a data standardization effect of the concatenated vector, thereby improving efficiency of processing the retrieval embedding vector by the target model. The mapping vector and the concatenated vector are concatenated to obtain the first feature of the to-be-retrieved data, so that the first feature may carry original information of the concatenated vector, thereby improving accuracy of the first feature.

It may be understood that, a second feature of the candidate image is obtained based on the target model in a manner similar to the manner obtaining the first feature of the to-be-retrieved data based on the target model. Similarly, the candidate image may be converted into an image embedding vector, and the image embedding vector is of the same vector format as the retrieval embedding vector. Normalization is performed on the image embedding vector, to obtain a first normalized vector corresponding to the candidate image. Attention feature extraction is performed on the first normalized vector corresponding to the candidate image, to obtain an attention vector corresponding to the candidate image. The attention vector corresponding to the candidate image and the image embedding vector are concatenated, to obtain a concatenated vector corresponding to the candidate image. Normalization is performed on the concatenated vector corresponding to the candidate image, to obtain a second normalized vector corresponding to the candidate image. Feed forward feature mapping is performed on the second normalized vector corresponding to the candidate image based on each modality alignment unit, to obtain a mapping vector corresponding to the candidate image. The mapping vector corresponding to the candidate image and the concatenated vector corresponding to the candidate image are concatenated, to obtain a second feature of the candidate image obtained after the candidate image is aligned with to-be-retrieved data in each modality.

Therefore, when the first feature of the to-be-retrieved data is obtained based on the target model, and the second feature of the candidate image is obtained based on the target model, the same first normalization layer, attention layer, and second normalization layer may be shared, and different feature extraction units are invoked to perform feature extraction or different modality alignment units are invoked to perform feature extraction, to simplify a structure of the target model.

For example, the to-be-retrieved data in the plurality of modalities includes the to-be-retrieved image and the to-be-retrieved text, when the processing modules are stacked in the target model, the concatenated vector may be collectively represented as follows:

Xᵢ^{v/t}=MSA(LN(Xᵢ₋₁^{v/t}))+Xᵢ₋₁^{v/t}

Xᵢ^{v/t} represents a concatenated vector that corresponds to the to-be-retrieved image, the to-be-retrieved text, or the candidate image and that is generated in an i^{th} processing module, i being a positive integer, MSA represents a multi-head attention mechanism, LN represents normalization, and Xᵢ₋₁^{v/t} represents a retrieval embedding vector inputted into the i^{th} processing module (which is a first feature corresponding to a to-be-retrieved image or a to-be-retrieved text outputted by an (i−1)^{th} processing module), i being a positive integer. When i=1, Xᵢ₋₁^{v/t} represents a retrieval embedding vector of the to-be-retrieved image or the to-be-retrieved text.

Correspondingly, the first feature and the second feature may be combined as follows:

Xᵢ^{img/viS/txt}=MLP_{img/vis/txt}(LN(Xᵢ^{v/t}))+Xᵢ^{v/t}

Xᵢ^{img/vis/txt} represents a first feature of the to-be-retrieved image or the to-be-retrieved text generated in the processing module or a second feature of the candidate image, and MLP represents feed forward mapping.

In a possible implementation, before the candidate image set and the to-be-retrieved data in the plurality of modalities are obtained, the target model may be first trained. To be specific, a sample image and sample retrieval data (“sample query data”) in at least one modality other than an image modality are obtained, and a similarity tag between the sample image and the sample retrieval data is obtained; feature extraction is performed on the sample retrieval data based on the target model to obtain a third feature of the sample retrieval data, and feature extraction is performed on the sample image based on the target model for a plurality of times, to obtain a fourth feature of the sample image obtained after the sample image is aligned with sample retrieval data in each modality; a second similarity between the sample image and the to-be-retrieved data is determined according to the third feature and the fourth feature, and a first loss value is determined according to the second similarity and the corresponding similarity tag; and a parameter of the target model is adjusted according to the first loss value.

Both the sample retrieval data and the sample image are configured for training the target model. Since the sample retrieval data and the sample image have different modalities, the sample retrieval data may be a sample text, sample voice, or the like. The similarity tag between the sample image and the sample retrieval data is configured for indicating whether the sample image matches the sample retrieval data. The similarity tag may be “1” or “0”. When the similarity tag is “1”, the sample retrieval data matches the corresponding sample image, for example, if the sample retrieval data is the sample text, and the sample text is “a boy carrying a schoolbag”, the sample image is an image of a boy carrying a schoolbag. When the similarity tag is “0”, the sample retrieval data does not match the corresponding sample image, for example, if the sample text is “a boy carrying a schoolbag”, the sample image is an image of a peony.

A principle of performing feature extraction on the sample retrieval data based on the target model to obtain the third feature of the sample retrieval data is similar to the principle of performing feature extraction on the to-be-retrieved data based on the target model to obtain the first feature of the to-be-retrieved data. Details are not described herein again. Similarly, a principle of performing feature extraction on the sample image based on the target model for a plurality times to obtain the fourth feature of the sample image obtained after the sample image is aligned with the sample retrieval data in each modality is similar to the principle of performing feature extraction on the candidate image based on the target model to obtain the second feature of the candidate image obtained after the candidate image is aligned with the to-be-retrieved data in each modality. Details are not described herein again. A manner of calculating the second similarity is similar to the manner of calculating the first similarity. Details are not described herein again. After the second similarity between the sample image and the to-be-retrieved data is determined, since the similarity tag between the corresponding sample image and the sample retrieval data is known, the first loss value may be determined according to the second similarity and the corresponding similarity tag, which may be specifically represented as follows:

$${L}_{1} = \frac{1}{B} {\sum }_{i = 1}^{B} {\sum }_{j = 1}^{B} ( {p}_{i , j} \cdot log \frac{{p}_{i , j}}{{q}_{i , j} + ∈} )$$

L₁ represents the first loss value, B represents a quantity of sample pairs formed by the sample retrieval data and sample images, i represents an i^{th} sample image, j represents a j^{th} piece of sample retrieval data, both i and j being positive integers, p_{i,j} represents a probability value obtained by normalizing the second similarity, q_{i,j} represents a probability value obtained by normalizing the similarity tag, and E represents a very small floating point number for stabilizing a numerical value (for example, preventing a denominator from being 0).

Specifically,

$${p}_{i , j} = \frac{exp ( {f}_{i}^{T} \cdot {f}_{j} )}{{\sum }_{k = 1}^{B} exp ( {f}_{i}^{T} \cdot {f}_{k} )} , {q}_{i , j} = \frac{{y}_{i , j}}{{\sum }_{k = 1}^{B} {y}_{i , k}}$$

fᵢ^{T} represents a transpose of a fourth feature of the i sample image, fⱼ represents a third feature of the j^{th} piece of sample retrieval data, fₖ represents a third feature of a k^{th} piece of sample retrieval data, y_{i,j} represents a similarity tag between the i^{th} sample image and the j^{th} piece of sample retrieval data, and y_{i,k} represents a similarity tag between the i^{th} sample image and the k^{th} piece of sample retrieval data.

Since the first loss value is determined based on the third feature and the fourth feature, that the parameter of the target model is adjusted according to the first loss value may be to adjust parameters of the modality alignment unit and the corresponding feature extraction unit in the target model, to achieve joint training between a modality alignment unit and a feature extraction unit in a corresponding modality, thereby effectively improving a degree of alignment between the modality alignment unit and the feature extraction unit in the corresponding modality, and improving training efficiency of the target model.

In a possible implementation, when the target model includes an image feature extraction unit and reuses the image feature extraction unit (that is, the image feature extraction unit is configured to perform feature extraction on the to-be-retrieved image and perform feature extraction on the candidate image), correspondingly, the parameter of the target model is adjusted according to the first loss value. To be specific, a category tag of the sample image is obtained; feature extraction is performed on the sample image based on the target model, to obtain a fifth feature that is of the sample image and that corresponds to the image modality; the sample image is classified according to the fifth feature to obtain a sample category, and a second loss value is determined according to the sample category and the category tag; and the parameter of the target model is adjusted according to the first loss value and the second loss value.

The category tag of the sample image is configured for indicating a category of the sample image. For example, if the sample image is an image of a dog, the category tag of the sample image is “animal”, “dog”, or the like. That feature extraction is performed on the sample image based on the target model may be to perform feature extraction on the sample image based on the image feature extraction unit, to obtain a fifth feature that is of the sample image and that corresponds to the image modality. After the fifth feature of the sample image is obtained, the fifth feature may be inputted into a classifier to perform classification on the sample image, to obtain a sample category, to further determine a second loss value according to the sample category and the category tag. The second loss value may be specifically represented as follows:

$${L}_{2} = {\sum }_{x = 1}^{m} p ( x ) log q ( x )$$

L₂ represents the second loss value, p(x) represents a probability distribution corresponding to the category tag, q (x) represents a probability distribution corresponding to the sample category, x represents a serial number of a category of the sample image, and m represents a total quantity of categories of the sample image, both x and m being positive integers.

In a possible implementation, that the parameter of the target model is adjusted according to the first loss value and the second loss value may be to independently adjust the parameter of the target model according to the first loss value and the second loss value, or may be to weight the first loss value and the second loss value to obtain a total loss value, and adjust the parameter of the target model according to the total loss value.

The category tag is introduced, and the sample image is classified according to the fifth feature, to further obtain the second loss value. Image classification may be introduced to adjust a parameter of the image feature extraction unit, so that a training manner in another scenario may be introduced to adjust the parameter of the image feature extraction unit, thereby improving a generalization capability of the image feature extraction unit.

In a possible implementation, when the target model includes the image feature extraction unit and reuses the image feature extraction unit, and the parameter of the target model is adjusted according to the first loss value, to be specific, a first reference image that is of a same category as the sample image and a second reference image that is of a different category than the sample image may be obtained; feature extraction is performed on the sample image, the first reference image, and the second reference image based on the target model, to obtain a fifth feature that is of the sample image and that corresponds to the image modality, a sixth feature of the first reference image, and a seventh feature of the second reference image; a third similarity between the fifth feature and the sixth feature and a fourth similarity between the fifth feature and the seventh feature are determined, and a third loss value is determined according to the third similarity and the fourth similarity; and the parameter of the target model is adjusted according to the first loss value and the third loss value.

There may be a plurality of sample images. For one of the sample images, the first reference image and the second reference image may be images in the plurality of sample images, or may be images other than the plurality of sample images. This is not limited in this embodiment of this application. That feature extraction is performed on the sample image, the first reference image, and the second reference image based on the target model is to perform feature extraction on the sample image, the first reference image, and the second reference image based on the image feature extraction unit. Since the first reference image is of the same category as the sample image, the third similarity is normally higher. Similarly, since the second reference image is of a different category than the sample image, the fourth similarity is normally lower. Correspondingly, the third loss value may be specifically represented as follows:

L₃=d_{AP}−d_{AN}+α

L₃ represents the third loss value, d_{AP} represents the third similarity, d_{AN} represents the fourth similarity, and a represents a hyperparameter.

In a possible implementation, that the parameter of the target model is adjusted according to the first loss value and the third loss value may be to independently adjust the parameter of the target model according to the first loss value and the third loss value, or may be to weight the first loss value and the third loss value to obtain a total loss value, and adjust the parameter of the target model according to the total loss value.

The third similarity and the fourth similarity are respectively determined by introducing the first reference image and the second reference image, to further obtain the third loss value. In this way, a distance between images of the same category may be closer, and a distance between images of different categories may be farther, so that features extracted by the feature extraction unit are more accurate.

In a possible implementation, the first loss value, the second loss value, and the third loss value may be weighted to obtain a total loss value, and the parameter of the target model is adjusted according to the total loss value. For example, when weight values of the first loss value, the second loss value, and the third loss value are 1, the total loss value may be represented as follows:

Lₜₒₜₐₗ=L₁+L₂+L₃

Lₜₒₜₐₗ represents the total loss value.

When the target model includes the image feature extraction unit and reuse the image feature extraction unit, targeted training may be performed on the image feature extraction unit and the modality alignment unit by simultaneously introducing the first loss value, the second loss value, and the third loss value, which is beneficial to improving a training effect.

A training process of the target model is described below by using an example in which the target model performs image retrieval based on the to-be-retrieved text and the to-be-retrieved image.

Refer to FIG. 6. FIG. 6 is an optional schematic diagram of a training process of a target model according to an embodiment of this application. Specifically, a sample image set and a sample text set may be obtained, the sample image set and sample text set are inputted into the target model, and feature extraction is performed on a sample text in the sample text set through a text feature extraction unit of the target model, to obtain a third feature of the sample text; feature extraction is performed on a sample image in the sample image set through a text modality alignment unit of the target model, to obtain a fourth feature of the sample image obtained after the sample image is aligned with the sample text; feature extraction is performed on the sample image in the sample image set through the image feature extraction unit of the target model, to obtain a fifth feature of the sample image; the first loss value is calculated by using the third feature and the fourth feature; the fifth feature is normalized, the normalized fifth feature is inputted into a classifier to obtain an image category of the sample image, and the second loss value is calculated according to the image category of the sample image and the category tag of the sample image; a first reference image and second reference image of each sample image is determined from the sample image set, the third loss value is calculated according to a similarity between the sample image and the first reference image and a similarity between the sample image and the second reference image; and a total loss value is obtained by summing the first loss value, the second loss value, and the third loss value, and the parameter of the target model is adjusted according to the total loss value.

In a possible implementation, during training of the target model, in a case that the sample retrieval data includes the sample text, a training sample of the target model may be expanded, to improve a training effect. When the sample image and the sample retrieval data in at least one modality other than the image modality are obtained, to be specific, an initial image and an initial text may be obtained; enhancement processing is performed on the initial image, to obtain an enhanced image; a text component of any length in the initial text is deleted to obtain an enhanced text, or a text component in the initial text is adjusted by using a text component in a reference text to obtain an enhanced text; and the initial image and the enhanced image are used as sample images, and the initial text and the enhanced text are used as sample texts.

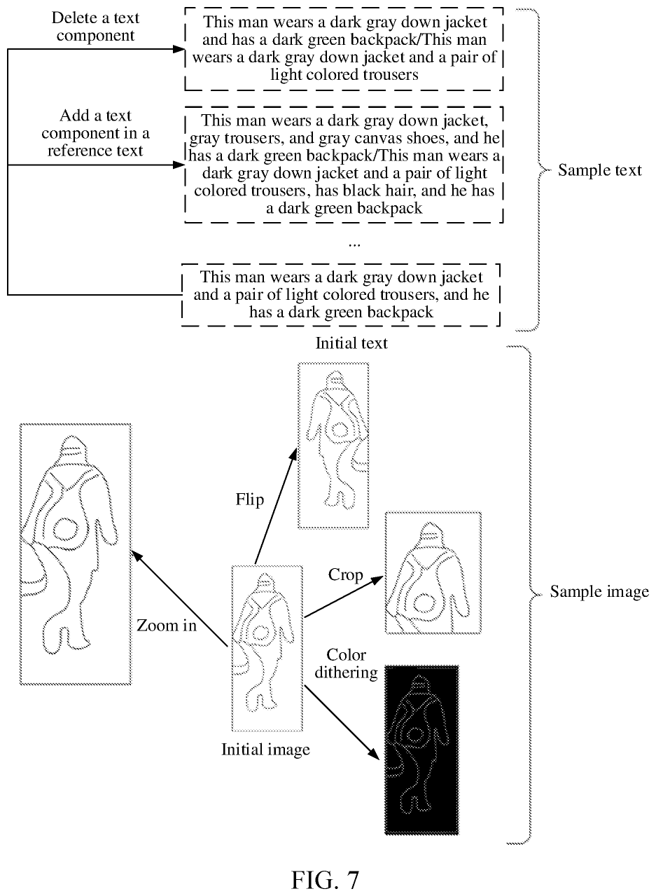

Specifically, referring to FIG. 7, FIG. 7 is an optional schematic flowchart of expanding a training sample according to an embodiment of this application. In a training data set, the initial image and the initial text may exist in pairs, there may be a plurality of data pairs formed by the initial image and the initial text, and the data pairs formed by the initial image and the initial text may be annotated with category tags.

For the initial image, enhancement processing may be performed on the initial image, to obtain an enhanced image. Enhancement processing includes but is not limited to one or a combination of more processing such as zooming in, zooming out, cropping, flipping, color gamut transformation, color dithering, and the like.

For the initial text, a text component of any length in the initial text may be deleted, to obtain an enhanced text. The text component may be a word, a sentence, or a paragraph. For example, if the initial text is “this man wears a dark gray down jacket and a pair of light colored trousers, and he has a dark green backpack”, the enhanced text may be “this man wears a dark gray down jacket and has a dark green backpack”, or the enhanced text may be “this man wears a dark gray down jacket and a pair of light colored trousers”, or the like. In addition, a text component in the initial text may also be adjusted by using a text component in a reference text, to obtain an enhanced text. The reference text is of the same category as the initial text, and a reference text of a current initial text may be determined from remaining initial texts in the training data set by using a category tag. That the text component in the initial text is adjusted by using the text component in the reference text may be to replace the text component in the initial text with the text component in the reference text, or may be to add the text component in the reference text based on the text component in the initial text. For example, if the initial text is “this man wears a dark gray down jacket and a pair of light colored trousers, and he has a dark green backpack”, and the reference text is “a man has black hair, wears a gray shirt, gray trousers, and gray canvas shoes, and carries a bag”, the enhanced text is “this man wears a dark gray down jacket, gray trousers, and gray canvas shoes, and he has a dark green backpack”, or the enhanced text may be “this man wears a dark gray down jacket and a pair of light colored trousers, has black hair, and he has a dark green backpack”, or the like.

The enhanced image and the enhanced text are obtained through processing above. Subsequently, the target model may be trained by using the enhanced image and the enhanced text. The initial image and the enhanced text, the enhanced image and the initial text, and the enhanced image and the enhanced text may all form new data pairs, which makes training data of the target model more diverse, especially when parameters of the modality alignment unit are adjusted, thereby significantly improving performance of the modality alignment unit.

Similarly, for initial voice, enhanced voice may also be obtained in a manner such as acceleration, deceleration, voice frame replacement, voice frame deletion, or noise addition, and training is performed on the target model by using the initial voice and the enhanced voice.

After training on the target model is completed, performance of the target model may be further verified when image retrieval is performed through the target model. Specifically, for a to-be-retrieved data combination including to-be-retrieved data in one modality, a cumulative matching characteristic (CMC) and mean average precision (mAP) may be calculated according to a first similarity in each modality. For a to-be-retrieved data combination including to-be-retrieved data in a plurality of modalities, the cumulative matching characteristic and the mean average precision may be calculated according to a target similarity in the plurality of modalities, to further verify performance of the target model from different dimensions. When the cumulative matching characteristic and the mean average precision do not reach a preset threshold, adjustment on the parameter of the target model may be performed again.

Performance of the target model in the image retrieval method provided in the embodiments of this application is described below by using CUHK-PEDES and RSTP data sets as an example.

Refer to Table 1 and Table 2. Table 1 shows evaluation effect data of different image retrieval methods on the CUHK-PEDES data set in the embodiments of this application. Table 2 shows evaluation effect data of different image retrieval methods on the RSTP data set in the embodiments of this application. Rank-1, Rank-5, and Rank-10 are evaluation indicators of the CMC. As can be seen from Table 1 and Table 2, the image retrieval method provided in this application has higher accuracy than other image retrieval methods in the related art, and the image retrieval method provided in this application only uses global features in data above.

TABLE 1
Evaluation effect data of different image retrieval
methods on the CUHK-PEDES data set

| Method | Feature | Rank-1 | Rank-5 | Rank-10 |
|---|---|---|---|---|
| GNA-RNN | Global | 19.05 | — | 53.64 |
| CNN-LSTM | Global | 58.94 | — | 60.48 |
| CMPM + CMPC | Global | 49.37 | — | 79.27 |
| MIA | Global + Local | 48.00 | 70.70 | 79.00 |
| A-GANet | Global + Local | 53.14 | 74.03 | 82.95 |
| PMA | Global + Local | 53.81 | 73.54 | 81.23 |
| HGAN | Global + Local | 59.00 | 79.49 | 86.63 |
| ViTTA | Global + Local | 55.97 | 75.84 | 83.52 |
| CMMT | Global + Local | 57.10 | 78.14 | 85.23 |
| DSSL | Global + Local | 59.98 | 80.41 | 87.56 |
| MGEL | Global + Local | 60.27 | 80.01 | 86.74 |
| NAFS | Global + Local | 61.50 | 81.19 | 87.51 |
| TBPS | Global + Local | 61.65 | 80.98 | 86.78 |
| This application | Global | 64.12 | 82.41 | 88.35 |

TABLE 2
Evaluation effect data of different image
retrieval methods on the RSTP data set

| Method | Feature | Rank-1 | Rank-5 | Rank-10 |
|---|---|---|---|---|
| DSSL | Global + Local | 32.43 | 55.08 | 63.19 |
| This application | Global | 42 | 65.55 | 74.15 |

Refer to Table 3 and Table 4. Table 3 shows evaluation effect data of performing image retrieval by using a text in different image retrieval methods provided in the embodiments of this application. Table 4 shows evaluation effect data of performing image retrieval by using an image in different image retrieval methods provided in the embodiments of this application. R1 is an abbreviation of Rank-1, R5 is an abbreviation of Rank-5, and R10 is an abbreviation of Rank-10. As can be seen from Table 3 and Table 4, when independently evaluating image retrieval performed by using a text and image retrieval performed by using an image, the image retrieval method provided in this application has higher accuracy than other image retrieval methods in the related art.

TABLE 3
Evaluation effect data of performing image retrieval
by using a text in different image retrieval methods

| | CUHK-PEDES | | | | RSTP | | | |
|---|---|---|---|---|---|---|---|---|
| Method | R1 | R5 | R10 | mAP | R1 | R5 | R10 | mAP |
| NAFS | 47.44 | 69.76 | 77.80 | 43.60 | 18.45 | 39.50 | 50.75 | 18.45 |
| TBPS | 51.34 | 73.54 | 81.71 | 49.75 | 18.25 | 38.75 | 46.75 | 17.96 |
| This | 55.49 | 75.85 | 83.17 | 52.74 | 21.75 | 39.75 | 48.75 | 18.97 |
| application | | | | | | | | |

TABLE 4
Evaluation effect data of performing image retrieval by
using an image in different image retrieval methods

| | CUHK-PEDES | | | | RSTP | | | |
|---|---|---|---|---|---|---|---|---|
| Method | R1 | R5 | R10 | mAP | R1 | R5 | R10 | mAP |
| NAFS | 91.10 | 97.32 | 97.68 | 78.79 | 74.25 | 90.50 | 94.50 | 56.55 |
| TBPS | 96.46 | 98.90 | 99.15 | 89.39 | 88.75 | 96.75 | 97.50 | 70.39 |
| This | 98.05 | 99.39 | 99.76 | 94.36 | 95.50 | 97.25 | 98.50 | 84.65 |
| application | | | | | | | | |

In addition, referring to Table 5, Table 5 shows evaluation effect data of performing image retrieval by using a text, performing image retrieval by using an image, and performing image retrieval by using a combination of the text and the image in the image retrieval method provided in the embodiments of this application. Image retrieval performed by using the combination of the text and the image has higher accuracy. Therefore, in this application similarities corresponding to to-be-retrieved data in different modalities are not fused, to implement image retrieval by using a combination of the to-be-retrieved data in different modalities, which can significantly image retrieval accuracy.

TABLE 5
Evaluation effect data of the image retrieval method
provided in the embodiments of this application

| | CUHK-PEDES | | | | RSTP | | | |
|---|---|---|---|---|---|---|---|---|
| Method | R1 | R5 | R10 | mAP | R1 | R5 | R10 | mAP |
| Text | 55.49 | 75.85 | 83.17 | 52.74 | 21.75 | 39.75 | 48.75 | 18.97 |
| Image | 98.05 | 99.39 | 99.76 | 94.39 | 95.50 | 97.25 | 98.50 | 84.65 |
| Combination | 98.29 | 99.63 | 99.76 | 99.76 | 95.50 | 97.50 | 98.50 | 85.00 |
| of text and | | | | | | | | |
| image | | | | | | | | |

An overall architecture of the target model in the embodiments of this application is described below by using a practical example.

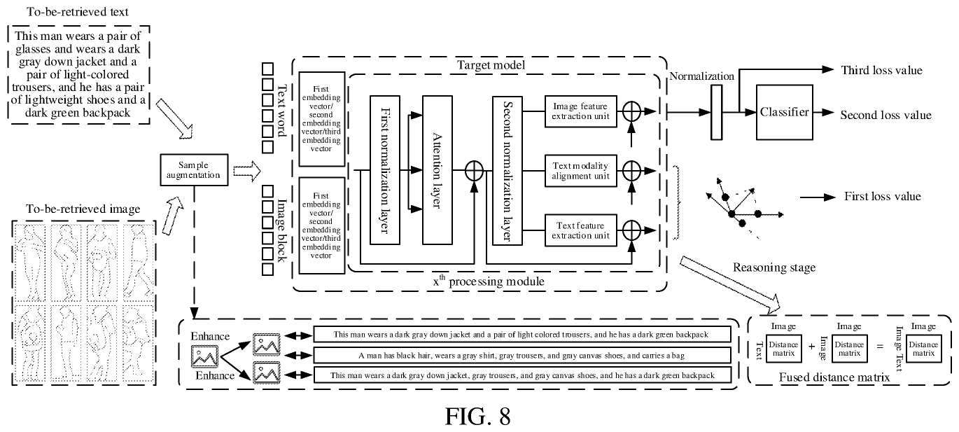

Refer to FIG. 8. FIG. 8 is an optional schematic diagram of an overall architecture of a target model according to an embodiment of this application. The target model includes a first normalization layer, an attention layer, a second normalization layer, an image feature extraction unit, a text modality alignment unit, and a text feature extraction unit.

In a training stage of the target model:

A plurality of data pairs formed by a sample text and a sample image are inputted, a sample text of one of the data pairs inputted may be “this man wears a pair of glasses and wears a dark gray down jacket and a pair of light-colored trousers, and he has a pair of lightweight shoes and a dark green backpack”, an inputted sample image is a character image. Intra-class text and image augmentation are performed. For the sample image, random enhancement processing may be performed, that is, the sample image is processed in one or more processing manners randomly selected from zooming in, zooming out, cropping, flipping, color gamut transformation, color dithering, and the like, and a text component of the sample text is adjusted, for example, texts “this man wears a dark gray down jacket and a pair of light colored trousers, and he has a dark green backpack”, “a man has black hair, wears a gray shirt, gray trousers, and gray canvas shoes, and carries a bag”, and “this man wears a dark gray down jacket, gray trousers, and gray canvas shoes, and he has a dark green backpack” may be obtained, an image obtained through enhancement ad a text obtained through text component adjustment may form a new data pair, thereby expanding training data of the target model. The data pairs are encoded to obtain an image embedding vector and a text embedding vector. The image embedding vector and the text embedding vector are inputted into the target model, and normalization by the first normalization layer, attention feature extraction by the attention layer, and normalization by the second normalization layer are performed to obtain an image normalized vector and a text normalized vector. According to a corresponding input type, feed forward mapping is performed on the image normalized vector through the image feature extraction unit to obtain an image feature of the sample image, feed forward mapping is performed on the text normalized vector through the text feature extraction unit to obtain a text feature of the sample text, and feed forward mapping is performed on the image normalized vector through the text modality alignment unit to obtain an image feature of the sample image obtained after the sample image is aligned with the sample text. Next, the first loss value is calculated based on the text feature of the sample text and the image feature of the sample image obtained after the sample image is aligned with the sample text, the second loss value and the third loss value are calculated based on the image feature of the sample image, and the parameter of the target model is adjusted according to the first loss value, the second loss value, and the third loss value.

In a reasoning stage of the target model:

A data pair <v_{q}, t_{q}> formed by a to-be-retrieved image and a to-be-retrieved text, and a candidate image <v_{g}> in a candidate image data set are inputted, a feature f_{q}^{img} of a to-be-retrieved image v_{q} and a feature f_{g}^{img} of a candidate image v_{g} are extracted through the image feature extraction unit of the target model, a feature f_{q}^{txt} of a to-be-retrieved text t_{q} is extracted through the text feature extraction unit of the target model, and a feature f_{g}^{vis} obtained after the candidate image v_{g} is aligned with the to-be-retrieved text t_{q} is extracted through the text modality alignment unit.

A Euclidean distance matrix between the to-be-retrieved text t_{q} and the candidate image v_{g} is calculated as follows: Dₜ₂ᵢ=dist(f_{q}^{txt}, f_{g}^{vis}) a result image set corresponding to the to-be-retrieved text t_{q} is determined from the candidate image data set according to the Euclidean distance matrix Dₜ₂ᵢ, and corresponding CMCₜ₂ᵢ and mAPₜ₂ᵢ are calculated according to the Euclidean distance matrix Dₜ₂ᵢ.

A Euclidean distance matrix between the to-be-retrieved image v_{q} and the candidate image v_{g} is calculated as follows: Dᵢ₂ᵢ=dist(f_{q}^{img}, f_{g}^{img}), a result image set corresponding to the to-be-retrieved image v_{q} is determined from the candidate image data set according to the Euclidean distance matrix Dᵢ₂ᵢ, and corresponding CMCᵢ₂ᵢ and mAPᵢ₂ᵢ are calculated according to the Euclidean distance matrix Dᵢ₂ᵢ.

A fused Euclidean distance matrix between the data pair <v_{q}, t_{q}> formed by the to-be-retrieved image and the to-be-retrieved text and the candidate image v_{g} is calculated as follows: Dₜᵢ₂ᵢ=λ·Dᵢ₂ᵢ+(1−λ)·Dₜ₂ᵢ, a result image set corresponding to the data pair <v_{q}, t_{q}> is determined from the candidate image data set according to the Euclidean distance matrix Dₜᵢ₂ᵢ, and corresponding CMCₜᵢ₂ᵢ and mAPₜᵢ₂ᵢ are calculated according to the fused Euclidean distance matrix Dₜᵢ₂ᵢ.

Finally, the result image set corresponding to the to-be-retrieved text t_{q}, the result image set corresponding to the to-be-retrieved image v_{q}, and the result image set corresponding to the data pair <v_{q}, t_{q}> are merged, to obtain an image retrieval result.

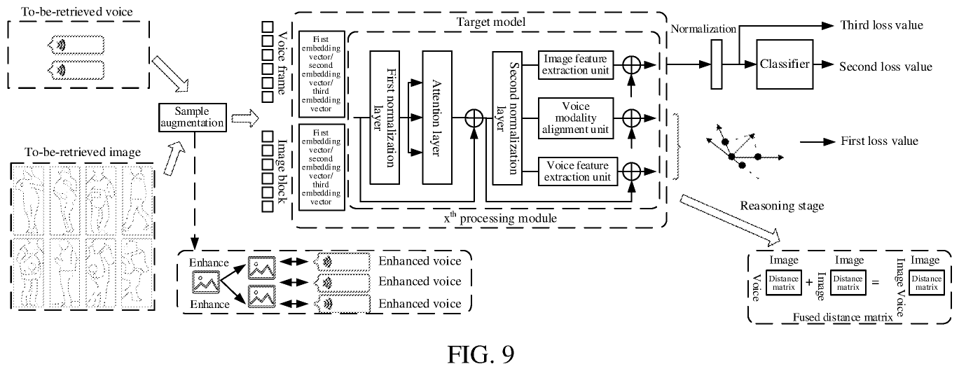

In addition, referring to FIG. 9, FIG. 9 is another optional schematic diagram of an overall architecture of a target model according to an embodiment of this application. The target model includes a first normalization layer, an attention layer, a second normalization layer, an image feature extraction unit, a voice modality alignment unit, and a voice feature extraction unit.

In a training stage of the target model:

A plurality of data pairs formed by sample voice and a sample image are inputted, the inputted sample image is a character image, the inputted sample voice is voice for describing a character in the sample image. Intra-class voice and image augmentation are performed. For the sample image, random enhancement may be performed, that is, the sample image is processed in one or more processing manners randomly selected from zooming in, zooming out, cropping, flipping, color gamut transformation, color dithering, and the like. For the sample voice, random enhancement may also be performed, that is, the sample voice is processed in one or more processing manners randomly selected from acceleration, deceleration, voice frame replacement, voice frame deletion, and noise addition. An image and voice obtained through enhancement may form a new data pair, thereby expanding training data of the target model. The data pairs are encoded to obtain an image embedding vector and a voice embedding vector. The image embedding vector and the voice embedding vector are inputted into the target model, and normalization by the first normalization layer, attention feature extraction by the attention layer, and normalization by the second normalization layer are performed to obtain an image normalized vector and a voice normalized vector. According to a corresponding input type, feed forward mapping is performed on the image normalized vector through the image feature extraction unit to obtain an image feature of the sample image, feed forward mapping is performed on the voice normalized vector through the voice feature extraction unit to obtain a voice feature of the sample voice, and feed forward mapping is performed on the image normalized vector through the voice modality alignment unit to obtain an image feature of the sample image obtained after the sample image is aligned with the sample voice. Next, the first loss value is calculated based on the voice feature of the sample voice and the image feature of the sample image obtained after the sample image is aligned with the sample voice, the second loss value and the third loss value are calculated based on the image feature of the sample image, and the parameter of the target model is adjusted according to the first loss value, the second loss value, and the third loss value.

In a reasoning stage of the target model:

A data pair <v_{q}, s_{q}> formed by a to-be-retrieved image and to-be-retrieved voice, and a candidate image <v_{g}> in a candidate image data set are inputted, a feature f_{q}^{img} of a to-be-retrieved image v_{q} and a feature f_{g}^{img} of a candidate image v_{g} are extracted through the image feature extraction unit of the target model, a feature f_{q}^{sou} of a to-be-retrieved voice s_{q} is extracted through the voice feature extraction unit of the target model, and a feature f_{g}^{voi} obtained after the candidate image v_{g} is aligned with the to-be-retrieved voice s_{q} is extracted through the voice modality alignment unit.

A Euclidean distance matrix between the to-be-retrieved voice s_{q} and the candidate image v_{g} is calculated as follows: Dₛ₂ᵢ=dist(f_{q}^{sou}, f_{g}^{voi}), a result image set corresponding to the to-be-retrieved voice s_{q} is determined from the candidate image data set according to the Euclidean distance matrix Dₛ₂ᵢ, and corresponding CMCₛ₂ᵢ and mAPₛ₂ᵢ are calculated according to the Euclidean distance matrix Dₛ₂ᵢ.

A Euclidean distance matrix between the to-be-retrieved image v_{q} and the candidate image v_{g} is calculated as follows: Dᵢ₂ᵢ=dist(fqimg, f_{g}^{img}), a result image set corresponding to the to-be-retrieved image v_{q} is determined from the candidate image data set according to the Euclidean distance matrix Dᵢ₂ᵢ, and corresponding CMCᵢ₂ᵢ and mAPᵢ₂ᵢ are calculated according to the Euclidean distance matrix Dᵢ₂ᵢ.

A fused Euclidean distance matrix between the data pair <v_{q}, s_{q}> formed by the to-be-retrieved image and the to-be-retrieved voice and the candidate image v_{g} is calculated as follows: Dₛᵢ₂ᵢ=λ·Dᵢ₂ᵢ+(1−λ)·Dₛ₂ᵢ, a result image set corresponding to the data pair <v_{q}, s_{q}> is determined from the candidate image data set according to the Euclidean distance matrix Dₛᵢ₂ᵢ, and corresponding CMCₛᵢ₂ᵢ and mAPₛᵢ₂ᵢ are calculated according to the fused Euclidean distance matrix Dₛᵢ₂ᵢ.

Finally, the result image set corresponding to the to-be-retrieved voice s_{q}, the result image set corresponding to the to-be-retrieved image v_{q}, and the result image set corresponding to the data pair <v_{q}, s_{q}> are merged, to obtain an image retrieval result.

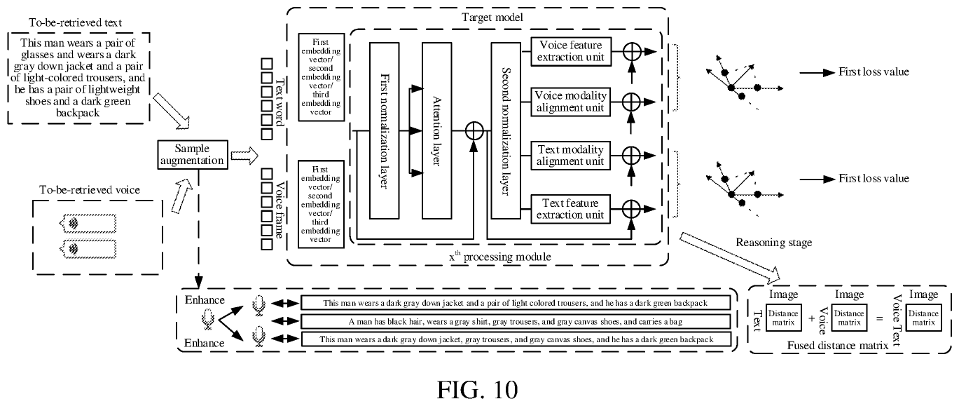

In addition, referring to FIG. 10, FIG. 10 is another optional schematic diagram of an overall architecture of a target model according to an embodiment of this application. The target model includes a first normalization layer, an attention layer, a second normalization layer, a text feature extraction unit, a text modality alignment unit, a voice modality alignment unit, and a voice feature extraction unit.

In a training stage of the target model:

A plurality of data pairs formed by the sample voice and the sample text, and the sample image are inputted. For the inputted sample text, reference may be made to the example shown in FIG. 7. Details are not described herein again. The inputted sample voice is voice for describing a character in the sample text. Intra-class voice, text, and image augmentation are performed. For details, reference may be made to the descriptions in the foregoing examples, which is not described herein again. The data pairs and the sample image are encoded to obtain a text embedding vector, a voice embedding vector, and an image embedding vector. The text embedding vector, the voice embedding vector, and the image embedding vector are inputted into the target model, and normalization by the first normalization layer, attention feature extraction by the attention layer, and normalization by the second normalization layer are performed to obtain a text normalized vector, a voice normalized vector, and an image normalized vector. According to a corresponding input type, feed forward mapping is performed on the text normalized vector through the text feature extraction unit to obtain an image feature of the sample text, feed forward mapping is performed on the voice normalized vector through the voice feature extraction unit to obtain a voice feature of the sample voice, feed forward mapping is performed on the image normalized vector through the voice modality alignment unit to obtain an image feature of the sample image after the sample image is aligned with the sample voice, and feed forward mapping is performed on the image normalized vector through the text modality alignment unit to obtain an image feature of the sample image obtained after the sample image is aligned with the sample text. Next, the first loss value is calculated based on the voice feature of the sample voice and the image feature of the sample image after the sample image is aligned with the sample voice, and the text feature of the sample text and the image feature of the sample image obtained after the sample image is aligned with the sample text, and the parameter of the target model is adjusted according to the first loss value.

In a reasoning stage of the target model:

A data pair <t_{q}, s_{q}> formed by a to-be-retrieved text and to-be-retrieved voice, and a candidate image <v_{g}> in a candidate image data set are inputted, a feature f_{q}^{txt} of a to-be-retrieved text v_{q} is extracted through the text feature extraction unit of the target model, a feature f_{q}^{sou} of to-be-retrieved voice s_{q} is extracted through the voice feature extraction unit of the target model, a feature f_{g}^{voi} obtained after the candidate image v_{g} is aligned with the to-be-retrieved voice is extracted through the voice modality alignment unit s_{q}, and a feature f_{g}^{vis} obtained after the candidate image v_{g} is aligned with the to-be-retrieved text t_{q} is extracted through the text modality alignment unit.

A Euclidean distance matrix between the to-be-retrieved voice s_{q} and the candidate image v_{g} is calculated as follows: Dₛ₂ᵢ=dist(f_{q}^{sou}, f_{g}^{voi}), a result image set corresponding to the to-be-retrieved voice s_{q} is determined from the candidate image data set according to the Euclidean distance matrix Dₛ₂ᵢ, and corresponding CMCₛ₂ᵢ and mAPₛ₂ᵢ are calculated according to the Euclidean distance matrix Dₛ₂ᵢ.

A Euclidean distance matrix between the to-be-retrieved text t_{q} and the candidate image v_{g} is calculated as follows: Dₜ₂ᵢ=dist(f_{q}^{txt}, f_{g}^{vis}) a result image set corresponding to the to-be-retrieved text t_{q} is determined from the candidate image data set according to the Euclidean distance matrix Dₜ₂ᵢ, and corresponding CMCₜ₂ᵢ and mAPₜ₂ᵢ are calculated according to the Euclidean distance matrix Dₜ₂ᵢ.

A fused Euclidean distance matrix between the data pair <t_{q}, s_{q}> formed by the to-be-retrieved text and the to-be-retrieved voice and the candidate image v_{g} is calculated as follows: Dₛₜ₂ᵢ=λ·Dₛ₂ᵢ+(1−λ)·Dₜ₂ᵢ, a result image set corresponding to the data pair <t_{q}, s_{q}> is determined from the candidate image data set according to the Euclidean distance matrix Dₛₜ₂ᵢ, and corresponding CMCₛₜ₂ᵢ and mAPₛₜ₂ᵢ are calculated according to the fused Euclidean distance matrix Dₛₜ₂ᵢ.

Finally, the result image set corresponding to the to-be-retrieved voice s_{q}, the result image set corresponding to the to-be-retrieved text t_{q}, and the result image set corresponding to the data pair <t_{q}, s_{q}> are merged, to obtain an image retrieval result.

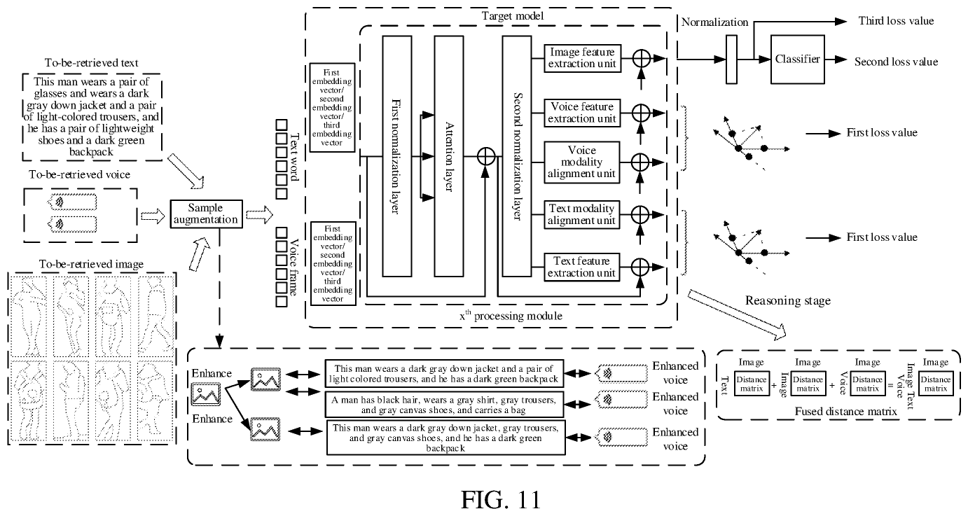

In addition, referring to FIG. 11, FIG. 11 is another optional schematic diagram of an overall architecture of a target model according to an embodiment of this application. The target model includes a first normalization layer, an attention layer, a second normalization layer, an image feature extraction unit, a text feature extraction unit, a text modality alignment unit, a voice modality alignment unit, and a voice feature extraction unit.

In a training stage of the target model:

A plurality of data pairs formed by the sample voice, the sample image, and the sample text are inputted. For the inputted sample text, reference may be made to the example shown in FIG. 7. Details are not described herein again. The inputted sample image is a character image, and the inputted sample voice is voice for describing a character in the sample text. Intra-class voice, text, and image augmentation are performed. For details, reference may be made to the descriptions in the foregoing examples, which is not described herein again. The data pairs are encoded to obtain a text embedding vector, a voice embedding vector, and an image embedding vector. The text embedding vector, the voice embedding vector, and the image embedding vector are inputted into the target model, and normalization by the first normalization layer, attention feature extraction by the attention layer, and normalization by the second normalization layer are performed to obtain a text normalized vector, a voice normalized vector, and an image normalized vector. According to a corresponding input type, feed forward mapping is performed on the image normalized vector through the image feature extraction unit to obtain an image feature of the sample image, feed forward mapping is performed on the text normalized vector through the text feature extraction unit to obtain an image feature of the sample text, feed forward mapping is performed on the voice normalized vector through the voice feature extraction unit to obtain a voice feature of the sample voice, feed forward mapping is performed on the image normalized vector through the voice modality alignment unit to obtain an image feature of the sample image after the sample image is aligned with the sample voice, and feed forward mapping is performed on the image normalized vector through the text modality alignment unit to obtain an image feature of the sample image obtained after the sample image is aligned with the sample text. Next, the first loss value is calculated based on the voice feature of the sample voice and the image feature of the sample image after the sample image is aligned with the sample voice, and the text feature of the sample text and the image feature of the sample image obtained after the sample image is aligned with the sample text, the second loss value and the third loss value are calculated based on the image feature of the sample image, and the parameter of the target model is adjusted according to the first loss value, the second loss value, and the third loss value.

In a reasoning stage of the target model:

A data pair <v_{q}, t_{q}, s_{q}> formed by a to-be-retrieved image, a to-be-retrieved text, and to-be-retrieved voice, and a candidate image <v_{g}> in a candidate image data set are inputted, a feature f_{q}^{img} of a to-be-retrieved image v_{q} and a feature f_{g}^{img} of a candidate image v_{g} are obtained through the image feature extraction unit of the target model, a feature f_{q}^{txt} of a to-be-retrieved text v_{q} is extracted through the text feature extraction unit of the target model, a feature f_{q}^{sou} of to-be-retrieved voice s_{q} is extracted through the voice feature extraction unit of the target model, a feature f_{g}^{voi} obtained after the candidate image v_{g} is aligned with the to-be-retrieved voice is extracted through the voice modality alignment unit s_{q}, and a feature f_{g}^{vis} obtained after the candidate image v_{g} is aligned with the to-be-retrieved text t_{q} is extracted through the text modality alignment unit.

A Euclidean distance matrix between the to-be-retrieved image v_{q} and the candidate image v_{g} is calculated as follows: Dᵢ₂ᵢ=dist(f_{q}^{img}, f_{g}^{img}), a result image set corresponding to the to-be-retrieved image v_{q} is determined from the candidate image data set according to the Euclidean distance matrix Dᵢ₂ᵢ, and corresponding CMCᵢ₂ᵢ and mAPᵢ₂ᵢ are calculated according to the Euclidean distance matrix Dᵢ₂ᵢ.

A Euclidean distance matrix between the to-be-retrieved voice s_{q} and the candidate image v_{g} is calculated as follows: Dₛ₂ᵢ=dist(f_{q}^{sou}, f_{g}^{voi}) a result image set corresponding to the to-be-retrieved voice s_{q} is determined from the candidate image data set according to the Euclidean distance matrix Dₛ₂ᵢ, and corresponding CMCₛ₂ᵢ and mAPₛ₂ᵢ are calculated according to the Euclidean distance matrix Dₛ₂ᵢ.

A Euclidean distance matrix between the to-be-retrieved text t_{q} and the candidate image v_{g} is calculated as follows: Dₜ₂ᵢ=dist(f_{q}^{txt}, f_{g}^{vis}) a result image set corresponding to the to-be-retrieved text t_{q} is determined from the candidate image data set according to the Euclidean distance matrix Dₜ₂ᵢ, and corresponding CMCₜ₂ᵢ and mAPₜ₂ᵢ are calculated according to the Euclidean distance matrix Dₜ₂ᵢ.

A fused Euclidean distance matrix between the data pair <v_{q}, t_{q}> formed by the to-be-retrieved image and the to-be-retrieved text and the candidate image v_{g} is calculated as follows: Dₜᵢ₂ᵢ=λ·Dᵢ₂ᵢ+(1−λ)·Dₜ₂ᵢ, a result image set corresponding to the data pair <v_{q}, t_{q}> is determined from the candidate image data set according to the Euclidean distance matrix Dₜᵢ₂ᵢ, and corresponding CMCₜᵢ₂ᵢ and mAPₜᵢ₂ᵢ are calculated according to the fused Euclidean distance matrix Dₜᵢ₂ᵢ.

A fused Euclidean distance matrix between the data pair <v_{q}, s_{q}> formed by the to-be-retrieved image and the to-be-retrieved voice and the candidate image v_{g} is calculated as follows: Dₛᵢ₂ᵢ=λ·Dᵢ₂ᵢ+(1−λ)·Dₛ₂ᵢ, a result image set corresponding to the data pair <v_{q}, s_{q}> is determined from the candidate image data set according to the Euclidean distance matrix Dₛᵢ₂ᵢ, and corresponding CMCₛᵢ₂ᵢ and mAPₛᵢ₂ᵢ are calculated according to the fused Euclidean distance matrix Dₛᵢ₂ᵢ.

A fused Euclidean distance matrix between the data pair <t_{q}, s_{q}> formed by the to-be-retrieved text and the to-be-retrieved voice and the candidate image v_{g} is calculated as follows: Dₛₜ₂ᵢ=λ·Dₛ₂ᵢ+(1−λ)·Dₜ₂ᵢ, a result image set corresponding to the data pair <t_{q}, s_{q}> is determined from the candidate image data set according to the Euclidean distance matrix Dₛₜ₂ᵢ, and corresponding CMCₛₜ₂ᵢ and mAPₛₜ₂ᵢ are calculated according to the fused Euclidean distance matrix Dₛₜ₂ᵢ.

A fused Euclidean distance matrix between the data pair <v_{q}, t_{q}, s_{q}> formed by the to-be-retrieved image, the to-be-retrieved text, and the to-be-retrieved voice and the candidate image v_{g} is calculated as follows: Dₛₜᵢ₂ᵢ=λ₁·Dᵢ₂ᵢ+λ₂·Dₜ₂ᵢ+(1−λ₁−λ₂)·Dₛ₂ᵢ, a result image set corresponding to the data pair <v_{q}, t_{q}, s_{q}> is determined from the candidate image data set according to the Euclidean distance matrix Dₛₜᵢ₂ᵢ, and corresponding CMCₛₜᵢ₂ᵢ and mAPₛₜᵢ₂ᵢ are calculated according to the fused Euclidean distance matrix Dₛₜᵢ₂ᵢ.

Finally, the result image set corresponding to the to-be-retrieved image v_{q}, the result image set corresponding to the to-be-retrieved voice s_{q}, the result image set corresponding to the to-be-retrieved text t_{q}, the result image set corresponding to the data pair <v_{q}, t_{q}>, the result image set corresponding to the data pair <v_{q}, s_{q}>, the result image set corresponding to the data pair <t_{q}, s_{q}>, and the result image set corresponding to the data pair <v_{q}, t_{q}, s_{q}> are merged, to obtain an image retrieval result.

λ, λ₁, and λ₂ represent weight values.

An application scenario of the image retrieval method provided in the embodiments of this application is described below by using two practical examples.

### Scenario 1

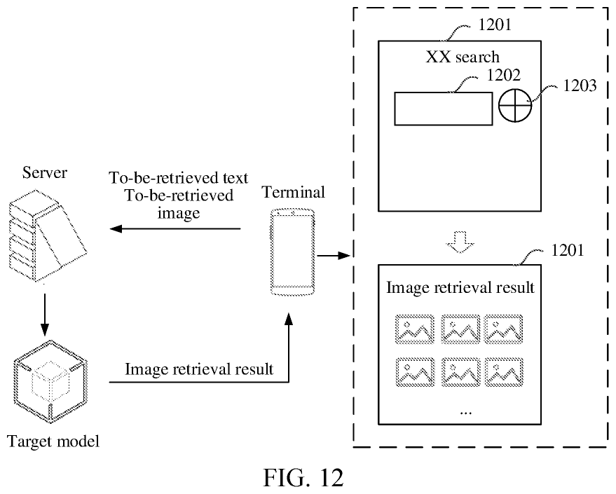

The image retrieval method provided in the embodiments of this application may be applied to a search engine. For example, refer to FIG. 12. FIG. 12 is a schematic flowchart of performing image retrieval by using a search engine according to an embodiment of this application. The terminal displays a search engine search interface 1201. The search engine search interface 1201 displays a first text input box 1202 for inputting a to-be-retrieved text and a first image input control 1203 for inputting a to-be-retrieved image. The terminal may send the to-be-retrieved text inputted from the first text input box 1202 and the to-be-retrieved image inputted from the first image input control 1203 to the server. Based on the to-be-retrieved text and the to-be-retrieved image, the server uses the image retrieval method to determine an image retrieval result from a preset image database and sends the image retrieval result to the terminal. The image retrieval result is displayed on the search engine search interface 1201 of the terminal.

### Scenario 2

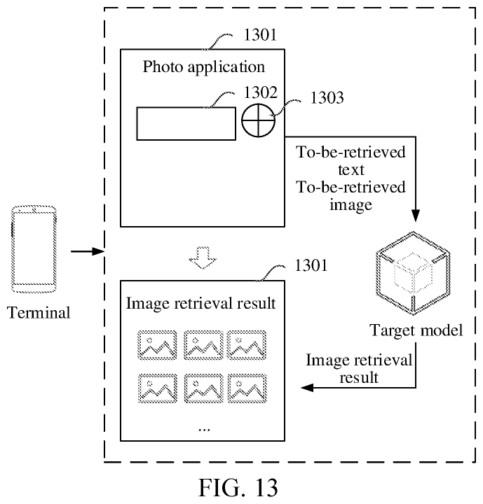

The image retrieval method provided in the embodiments of this application may be applied to the photo application. For example, refer to FIG. 13. FIG. 13 is a schematic flowchart of performing image retrieval on a photo application according to an embodiment of this application. The terminal displays a photo search interface of the photo application. 1301. The photo search interface 1301 displays a second text input box 1302 for inputting a to-be-retrieved text and a second image input control 1303 for inputting a to-be-retrieved image. The terminal obtains the to-be-retrieved text inputted from the second text input box 1302 and the to-be-retrieved image inputted from the second image input control 1303, determines an image retrieval result a photo database of the terminal based on the to-be-retrieved text and the to-be-retrieved image by using the image retrieval method, and displays the image retrieval result on the photo search interface 1301.

It may be understood that although the steps in the flowchart are sequentially shown according to indication of an arrow, the steps are not necessarily sequentially performed according to a sequence indicated by the arrow. Unless clearly specified in this embodiment, there is no strict sequence limitation on the execution of the steps, and the steps may be performed in another sequence. In addition, at least some steps in the flowcharts may include a plurality of steps or a plurality of stages. The steps or the stages are not necessarily performed at the same moment, but may be performed at different moments. The steps or the stages are not necessarily performed in sequence, but may be performed in turn or alternately with another step or at least some of steps or stages of the another step.

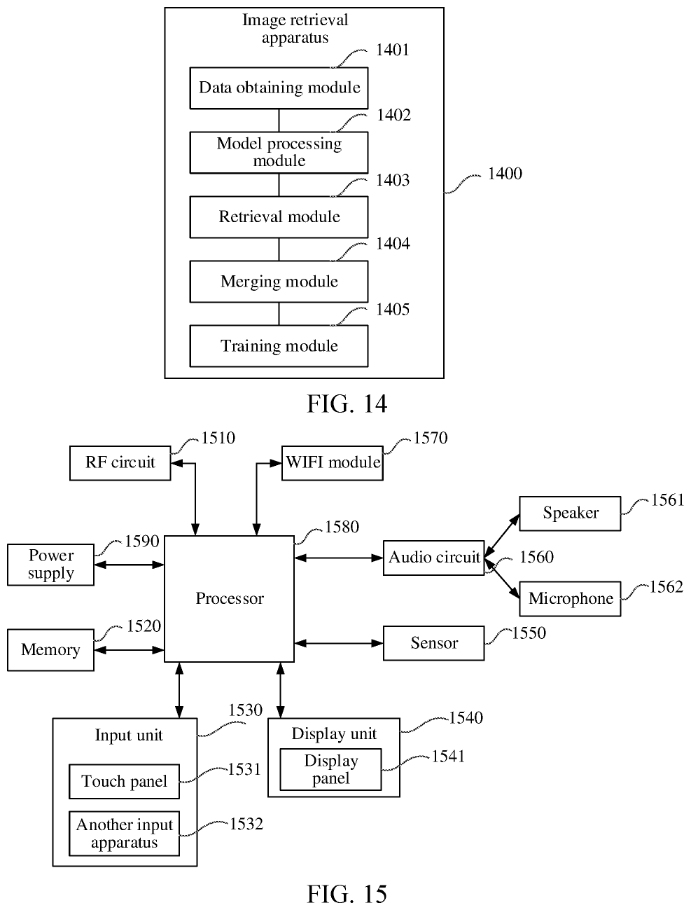

Refer to FIG. 14. FIG. 14 is an optional schematic structural diagram of an image retrieval apparatus according to an embodiment of this application.

In some embodiments, the image retrieval apparatus 1400 is applicable to the electronic device.

In some embodiments, the image retrieval apparatus 1400 includes:
a data obtaining module 1401, configured to obtain a candidate image set and to-be-retrieved data in a plurality of modalities, the candidate image set including a plurality of candidate images;
a model processing module 1402, configured to perform feature extraction on the to-be-retrieved data based on a target model to obtain a first feature of the to-be-retrieved data, and perform feature extraction on the candidate image based on the target model for a plurality times, to obtain a second feature of the candidate image obtained after the candidate image is aligned with to-be-retrieved data in each modality;
a retrieval module 1403, configured to determine a first similarity between the candidate image and the to-be-retrieved data in each modality according to the first feature and the second feature, and determine result image sets corresponding to a plurality of to-be-retrieved data combinations from the candidate image set according to the first similarity, the to-be-retrieved data combination including to-be-retrieved data in at least one modality; and
a merging module 1404, configured to merge a plurality of result image sets to obtain an image retrieval result.

Further, the model processing module 1402 is further configured to:
convert the to-be-retrieved data into a retrieval embedding vector, where the to-be-retrieved data in different modalities are converted into the retrieval embedding vector in a same vector format; and
input the retrieval embedding vector into the target model, and perform feature mapping on the to-be-retrieved data based on the target model, to obtain the first feature of the to-be-retrieved data.

Further, the model processing module 1402 is further configured to:
segment the to-be-retrieved data to obtain a plurality of to-be-retrieved data blocks, and perform feature mapping on the plurality of to-be-retrieved data blocks to obtain a first embedding vector;
determine location information of each to-be-retrieved data block in the to-be-retrieved data, and perform feature mapping on a plurality of pieces of location information to obtain a second embedding vector;
perform feature mapping on a modality corresponding to the to-be-retrieved data, to obtain a third embedding vector; and
concatenate the first embedding vector, the second embedding vector, and the third embedding vector, to obtain the retrieval embedding vector.

Further, the model processing module 1402 is further configured to:
normalize the retrieval embedding vector, to obtain a first normalized vector;
perform attention feature extraction on the first normalized vector, to obtain an attention vector; and

perform feature mapping on the attention vector based on the target model, to obtain the first feature of the to-be-retrieved data.

Further, the model processing module 1402 is further configured to:
concatenate the attention vector and the retrieval embedding vector, to obtain a concatenated vector;
normalize the concatenated vector to obtain a second normalized vector;
perform feed forward feature mapping on the second normalized vector based on the target model, to obtain a mapping vector; and
concatenate the mapping vector and the concatenated vector to obtain the first feature of the to-be-retrieved data.

Further, the to-be-retrieved data in the plurality of modalities includes a to-be-retrieved text and a to-be-retrieved image, the target model includes a text modality alignment unit that is configured to align the candidate image with the to-be-retrieved text and an image feature extraction unit that is configured to perform feature extraction on the to-be-retrieved image. The model processing module 1402 is further configured to:
perform feature extraction on the candidate image based on the text modality alignment unit, to obtain the second feature of the candidate image obtained after the candidate image is aligned with the to-be-retrieved text; and
perform feature extraction on the candidate image based on the image feature extraction unit to obtain an image feature of the candidate image, and use the image feature as the second feature of the candidate image obtained after the candidate image is aligned with the to-be-retrieved image.

Further, the plurality of to-be-retrieved data combinations include a first data combination and a second data combination, the first data combination includes to-be-retrieved data in one modality, the second data combination includes to-be-retrieved data in a plurality of modalities. The retrieval module 1403 is further configured to:
determine a result image set corresponding to the first data combination from the candidate image set according to a first similarity corresponding to the to-be-retrieved data in one modality; and
fuse first similarities corresponding to the to-be-retrieved data in the plurality of modalities to obtain a target similarity, and determine a result image set corresponding to the second data combination from the candidate image set according to the target similarity.

Further, the image retrieval apparatus further includes a training module 1405. The training module 1405 is configured to:
obtain a sample image and sample retrieval data in at least one modality other than an image modality, and obtain a similarity tag between the sample image and the sample retrieval data;
perform feature extraction on the sample retrieval data based on the target model to obtain a third feature of the sample retrieval data, and perform feature extraction on the sample image based on the target model for a plurality of times, to obtain a fourth feature of the sample image obtained after the sample image is aligned with sample retrieval data in each modality;
determine a second similarity between the sample image and the to-be-retrieved data according to the third feature and the fourth feature, and determine a first loss value according to the second similarity and the corresponding similarity tag; and
adjust a parameter of the target model according to the first loss value.

Further, the training module 1405 is further configured to:
obtain a category tag of the sample image;
perform feature extraction on the sample image based on the target model, to obtain a fifth feature that is of the sample image and that corresponds to the image modality;
classify the sample image according to the fifth feature to obtain a sample category, and determine a second loss value according to the sample category and the category tag; and
adjust the parameter of the target model according to the first loss value and the second loss value.

Further, the training module 1405 is further configured to:
obtain a first reference image that is of a same category as the sample image and a second reference image that is of a different category than the sample image;
perform feature extraction on the sample image, the first reference image, and the second reference image based on the target model, to obtain a fifth feature that is of the sample image and that corresponds to the image modality, a sixth feature of the first reference image, and a seventh feature of the second reference image;
determine a third similarity between the fifth feature and the sixth feature and a fourth similarity between the fifth feature and the seventh feature, and determine a third loss value according to the third similarity and the fourth similarity; and
adjust the parameter of the target model according to the first loss value and the third loss value.

Further, the training module 1405 is further configured to:
obtain an initial image and an initial text;
perform enhancement processing on the initial image, to obtain an enhanced image;
delete a text component of any length in the initial text to obtain an enhanced text, or adjust a text component in the initial text by using a text component in a reference text to obtain an enhanced text, where the reference text is of a same category as the initial text; and
use the initial image and the enhanced image as sample images, and use the initial text and the enhanced text as sample texts.

The image retrieval apparatus 1400 is based on the same inventive concept as the image retrieval method. The image retrieval apparatus 1400 performs feature extraction on the to-be-retrieved data through the target model to obtain a first feature of the to-be-retrieved data, and then performs feature extraction on the candidate image through the same target model for a plurality of times to obtain a second feature of the candidate image obtained after the candidate image is aligned with to-be-retrieved data in each modality, which can improve image retrieval accuracy by using to-be-retrieved data in a plurality of modalities, and unify feature frameworks of the to-be-retrieved data in the plurality of modalities and the candidate image, thereby improving feature space consistency between the first feature and the second feature. Moreover, the server determines the first feature and the second feature by using the same target model, which can reduce a quantity of parameters of the target model, and reduce memory overheads for deploying the target model. In addition, only the same target model needs to be trained in a training stage, which improves model training efficiency. Based on the above, the server determines a first similarity between the candidate image and to-be-retrieved data in each modality according to the first feature and the second feature, determines result image sets corresponding to a plurality of to-be-retrieved data combinations from the candidate image set according to the first similarity, and merges a plurality of result image sets to obtain an image retrieval result. In this way, there is no need to retrieve the to-be-retrieved data and the candidate images in a one-to-one manner, so that image retrieval efficiency is effectively improved. In addition, the image retrieval result is obtained based on the result image sets corresponding to the plurality of to-be-retrieved data combinations, which can effectively improve image retrieval accuracy.

The electronic device that is provided in the embodiments of this application and that is configured to perform the image retrieval method may be a terminal. Refer to FIG. 15. FIG. 15 is a block diagram of a structure of a part of a terminal according to an embodiment of this application. The terminal includes components such as a radio frequency (RF) circuit 1510, a memory 1520, an input unit 1530, a display unit 1540, a sensor 1550, an audio circuit 1560, a wireless fidelity (Wi-Fi) module 1570, a processor 1580, and a power supply 1590. A person skilled in the art may understand that the terminal structure shown in FIG. 15 does not constitute a limitation on the terminal, and may include more or fewer components than shown, or combine some components, or have different component arrangements.

The RF circuit 1510 may be configured to send and receive a signal in an information receiving and sending process or a call process, and in particular, after downlink information of a base station is received, send the downlink information to the processor 1580 for processing. In addition, the RF circuit transmits uplink data to the base station.

The memory 1520 may be configured to store a software program and module. The processor 1580 runs the software program and module stored in the memory 1520, to implement various functional applications and data processing of the terminal.

The input unit 1530 may be configured to receive input digit or character information, and generate key signal input related to the setting and function control of the terminal. Specifically, the input unit 1530 may include a touch panel 1531 and another input apparatus 1532.

The display unit 1540 may be configured to display inputted information or provided information, and various menus of the terminal. The display unit 1540 may include a display panel 1541.

The audio circuit 1560, a speaker 1561, and a microphone 1562 may provide audio interfaces.

In this embodiment, the processor 1580 included in the terminal may perform the image retrieval method in the foregoing embodiments.

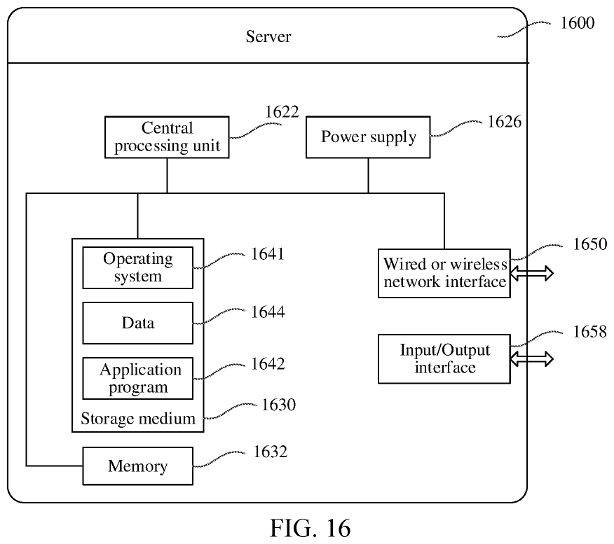

The electronic device provided in the embodiments of this application and configured to perform the image retrieval method may be a server. Refer to FIG. 16. FIG. 16 is a block diagram of a structure of a part of a server according to an embodiment of this application. The server 1600 may vary greatly due to different configurations or performance, and may include one or more central processing units (CPU) 1622 (for example, one or more processors) and a memory 1632, and one or more storage media 1630 (for example, one or more mass storage devices) that store an application program 1642 or data 1644. The memory 1632 and the storage mediums 1630 may be used for transient storage or permanent storage. The programs stored in the storage media 1630 may include one or more modules (not shown in the figure), and each module may include a series of instructions to the server 1600. Furthermore, the central processing unit 1622 may be configured to communicate with the storage medium 1630 to perform the series of instruction operations in the storage medium 1630 on the server 1600.

The server 1600 may further include one or more power supplies 1626, one or more wired or wireless network interfaces 1650, one or more input/output interfaces 1658, and/or, one or more operating systems 1641, for example, Windows Server™, Mac OS X™, Unix™, Linux™, and FreeBSD™.

The processor in the server 1600 may be configured to perform the image retrieval method.

An embodiment of this application further provides a computer-readable storage medium, configured to store a program code, the program code being used for performing the image retrieval method according to the foregoing embodiments.

An embodiment of this application further provides a computer program product, the computer program product including a computer program, the computer program being stored in a computer-readable storage medium. A processor of a computer device reads the computer program from the computer-readable storage medium, and the processor executes the computer program, to enable the computer device to perform the image retrieval method.

The terms such as “first”, “second”, “third”, and “fourth” (if any) in the specification and accompanying drawings of this application are used for distinguishing similar objects and not necessarily used for describing any particular order or sequence. Data used in this way is interchangeable in a suitable case, so that the embodiments of this application described herein can be implemented in a sequence in addition to the sequence shown or described herein. Moreover, the terms “include”, “contain”, and any other variants thereof mean to cover the non-exclusive inclusion. For example, a process, method, system, product, or apparatus that includes a list of steps or units is not necessarily limited to those steps or units that are clearly listed, but may include other steps or units not expressly listed or inherent to such a process, method, system, product, or apparatus.

It may be understood that, in this application, “at least one (item)” refers to one or more, and “a plurality of” refers to two or more. The term “and/or” is used for describing an association relationship between associated objects, and represents that three relationships may exist. For example, “A and/or B” may represent the following three cases: Only A exists, only B exists, and both A and B exist, where A and B may be singular or plural. The character “I” generally indicates an “or” relationship between the associated objects. “At least one of the following items” or a similar expression means any combination of these items, including a single item or any combination of a plurality of items. For example, at least one of a, b, or c may indicate a, b, c, “a and b”, “a and c”, “b and c”, or “a, b, and c”, where a, b, and c may be singular or plural.

It may be understood that, “a plurality of (items)” means more than two, “greater than”, “less than”, “exceeding”, and the like in the embodiments of this application are understood as not including the current number, and “above”, “below”, “within” and the like are understood as including the current number.

In the several embodiments provided in this application, the disclosed system, apparatus, and method may be implemented in other manners. For example, the described apparatus embodiments above are merely exemplary. For example, the unit division is merely logical function division and there may be other division manners during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts can or cannot be physically separate. Parts displayed as units can or cannot be physical units, and can be located in one position, or can be distributed on a plurality of network units. Some or all of the units may be selected according to actual requirements to achieve the objectives of the solutions of the embodiments.

In addition, functional units in the embodiments of this application may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this application essentially, or the part contributing to the related technology, or all or some of the technical solutions may be implemented in the form of a software product. The computer software product is stored in a storage medium and includes several instructions for instructing a computer device (which may be a personal computer, a server, a network device, or the like) to perform all or some of the steps of the methods described in the embodiments of this application. The foregoing storage medium includes various media capable of storing program codes, such as, a USB flash drive, a mobile hard disk, a Read Only Memory (ROM), a Random Access Memory (RAM), a magnetic disk, or an optical disc.

It may be further understood that, the implementations provided in the embodiments of this application may be randomly combined to achieve different technical effects.

The exemplary embodiments of this application are described in detail above. However, this application is not limited to the foregoing implementations. A person skilled in the art may also make various equivalent modifications or replacements without departing from the spirit of this application, and these equivalent modifications or replacements shall fall within the scope defined by claims of this application.

What is claimed is:

1. An image retrieval method comprising:
obtaining, by an electronic device, a candidate image set and query data in a plurality of modalities, the candidate image set including a plurality of candidate images;
performing, by the electronic device, feature extraction on the query data based on a target model to obtain a plurality of first features of the query data;
performing, by the electronic device, feature extraction on the candidate images based on the target model, to obtain a plurality of second features of the candidate images, each of the second features being obtained by feature extraction after the candidate images are aligned with the query data in one of the modalities;
determining, by the electronic device, a plurality of similarities each between the candidate images and the query data in one of the modalities according to the first features and the second features;
determining, by the electronic device, result image sets corresponding to a plurality of query data combinations from the candidate image set according to the similarities, the query data combinations including the query data in at least one of the modalities; and
merging, by the electronic device, the result image sets to obtain an image retrieval result.

2. The image retrieval method according to claim 1, wherein:
the query data in the plurality of modalities includes query text and a query image, and the target model includes a text modality alignment unit and an image feature extraction unit; and
performing feature extraction on the candidate images based on the target model, to obtain the second features includes:
performing, by the electronic device, feature extraction on the candidate images based on the text modality alignment unit, to obtain the second feature of the candidate images obtained after the candidate images are aligned with the query text; and
performing, by the electronic device, feature extraction on the candidate images based on the image feature extraction unit to obtain an image feature of the candidate images as the second feature of the candidate images obtained after the candidate images are aligned with the query image.

3. The image retrieval method according to claim 1, wherein:
the plurality of query data combinations include a first data combination and a second data combination, the first data combination includes the query data in one modality of the plurality of modalities, and the second data combination includes the query data in two or more modalities of the plurality of modalities; and
determining the result image sets includes:
determining, by the electronic device, a result image set corresponding to the first data combination from the candidate image set according to one of the similarities corresponding to the query data in the one modality; and
fusing, by the electronic device, two or more of the similarities corresponding to the query data in the two or more modalities to obtain a target similarity, and determining a result image set corresponding to the second data combination from the candidate image set according to the target similarity.

4. The image retrieval method according to claim 1, wherein performing feature extraction on the query data based on the target model to obtain the first features includes:
converting, by the electronic device, the query data in the plurality of modalities into retrieval embedding vectors in a same vector format; and
inputting, by the electronic device, the retrieval embedding vectors into the target model, and performing feature mapping on the query data based on the target model, to obtain the first features.

5. The image retrieval method according to claim 4, wherein converting the query data into the retrieval embedding vectors includes:
segmenting, by the electronic device, the query data to obtain a plurality of query data blocks;
performing, by the electronic device, feature mapping on the plurality of query data blocks to obtain a plurality of first embedding vectors;
determining, by the electronic device, a plurality of pieces of location information of the query data blocks in the query data, and performing feature mapping on the plurality of pieces of location information to obtain a plurality of second embedding vectors;
performing, by the electronic device, feature mapping on the plurality of modalities corresponding to the query data, to obtain a plurality of third embedding vectors; and
concatenating, by the electronic device, the first embedding vectors, the second embedding vectors, and the third embedding vectors, to obtain the retrieval embedding vectors.

6. The image retrieval method according to claim 4, wherein performing feature mapping on the query data based on the target model, to obtain the first features includes:
normalizing, by the electronic device, the retrieval embedding vectors, to obtain normalized vectors;
performing, by the electronic device, attention feature extraction on the normalized vectors, to obtain attention vectors; and
performing, by the electronic device, feature mapping on the attention vectors based on the target model, to obtain the first features.

7. The image retrieval method according to claim 6, wherein:
the normalized vectors are first normalized vectors; and
performing feature mapping on the attention vector based on the target model, to obtain the first features includes:
concatenating, by the electronic device, the attention vectors and the retrieval embedding vectors, to obtain concatenated vectors;
normalizing, by the electronic device, the concatenated vectors, to obtain second normalized vectors;
performing, by the electronic device, feed forward feature mapping on the second normalized vectors based on the target model, to obtain mapping vectors; and
concatenating, by the electronic device, the mapping vectors and the concatenated vectors, to obtain the first features.

8. The image retrieval method according to claim 1,
wherein the similarities are first similarities;
the image retrieval method further comprising, before obtaining the candidate image set and the query data:
obtaining, by the electronic device, a sample image and sample retrieval data in a modality other than an image modality, and obtaining a similarity tag between the sample image and the sample retrieval data;
performing, by the electronic device, feature extraction on the sample retrieval data based on the target model to obtain a third feature of the sample retrieval data, and performing feature extraction on the sample image based on the target model, to obtain a fourth feature of the sample image obtained after the sample image is aligned with the sample retrieval data;
determining, by the electronic device, a second similarity between the sample image and the query data according to the third feature and the fourth feature, and determining a loss value according to the second similarity and the similarity tag; and
adjusting, by the electronic device, a parameter of the target model according to the loss value.

9. The image retrieval method according to claim 8, wherein:
the loss value is a first loss value; and
adjusting the parameter of the target model includes:
obtaining, by the electronic device, a category tag of the sample image;
performing, by the electronic device, feature extraction on the sample image based on the target model, to obtain a fifth feature that is of the sample image and that corresponds to the image modality;
classifying, by the electronic device, the sample image according to the fifth feature to obtain a sample category, and determining, by the electronic device, a second loss value according to the sample category and the category tag; and
adjusting, by the electronic device, the parameter of the target model according to the first loss value and the second loss value.

10. The image retrieval method according to claim 8, wherein:
the loss value is a first loss value; and
adjusting the parameter of the target model includes:
obtaining, by the electronic device, a first reference image that is of a same category as the sample image and a second reference image that is of a different category than the sample image;
performing, by the electronic device, feature extraction on the sample image, the first reference image, and the second reference image based on the target model, to obtain a fifth feature that is of the sample image and that corresponds to the image modality, a sixth feature of the first reference image, and a seventh feature of the second reference image;
determining, by the electronic device, a third similarity between the fifth feature and the sixth feature and a fourth similarity between the fifth feature and the seventh feature, and determining, by the electronic device, a second loss value according to the third similarity and the fourth similarity; and
adjusting, by the electronic device, the parameter of the target model according to the first loss value and the second loss value.

11. The image retrieval method according to claim 8, wherein:
the sample retrieval data comprises sample text; and
obtaining the sample image and the sample retrieval data includes:
obtaining, by the electronic device, an initial image and initial text;
performing, by the electronic device, enhancement processing on the initial image, to obtain an enhanced image;
deleting, by the electronic device, a text component of any length in the initial text, or adjusting a text component in the initial text by using a text component in reference text, to obtain enhanced text, the reference text being of a same category as the initial text; and
using, by the electronic device, the initial image and the enhanced image as sample images, and using the initial text and the enhanced text as sample text.

12. An electronic device comprising:
one or more processors; and
one or more memories storing at least one computer program that, when executed by the one or more processors, causes the one or more processors to:
obtain a candidate image set and query data in a plurality of modalities, the candidate image set including a plurality of candidate images;
perform feature extraction on the query data based on a target model to obtain a plurality of first features of the query data;
perform feature extraction on the candidate images based on the target model, to obtain a plurality of second features of the candidate images, each of the second features being obtained by feature extraction after the candidate images are aligned with the query data in one of the modalities;
determine a plurality of similarities each between the candidate images and the query data in one of the modalities according to the first features and the second features;
determine result image sets corresponding to a plurality of query data combinations from the candidate image set according to the similarities, the query data combinations including the query data in at least one of the modalities; and
merge the result image sets to obtain an image retrieval result.

13. The electronic device according to claim 12, wherein:
the query data in the plurality of modalities includes query text and a query image, and the target model includes a text modality alignment unit and an image feature extraction unit; and
the at least one computer program further causes the one or more processors to:
perform feature extraction on the candidate images based on the text modality alignment unit, to obtain the second feature of the candidate images obtained after the candidate images are aligned with the query text; and
perform feature extraction on the candidate images based on the image feature extraction unit to obtain an image feature of the candidate images as the second feature of the candidate images obtained after the candidate images are aligned with the query image.

14. The electronic device according to claim 12, wherein:
the plurality of query data combinations include a first data combination and a second data combination, the first data combination includes the query data in one modality of the plurality of modalities, and the second data combination includes the query data in two or more modalities of the plurality of modalities; and
the at least one computer program further causes the one or more processors to:
determine a result image set corresponding to the first data combination from the candidate image set according to one of the similarities corresponding to the query data in the one modality; and
fuse two or more of the similarities corresponding to the query data in the two or more modalities to obtain a target similarity, and determining a result image set corresponding to the second data combination from the candidate image set according to the target similarity.

15. The electronic device according to claim 12, wherein the at least one computer program further causes the one or more processors to:
convert the query data in the plurality of modalities into retrieval embedding vectors in a same vector format; and
input the retrieval embedding vectors into the target model, and performing feature mapping on the query data based on the target model, to obtain the first features.

16. The electronic device according to claim 15, wherein the at least one computer program further causes the one or more processors to:
segment the query data to obtain a plurality of query data blocks;
perform feature mapping on the plurality of query data blocks to obtain a plurality of first embedding vectors;
determine a plurality of pieces of location information of the query data blocks in the query data, and performing feature mapping on the plurality of pieces of location information to obtain a plurality of second embedding vectors;
perform feature mapping on the plurality of modalities corresponding to the query data, to obtain a plurality of third embedding vectors; and
concatenate the first embedding vectors, the second embedding vectors, and the third embedding vectors, to obtain the retrieval embedding vectors.

17. The electronic device according to claim 15, wherein the at least one computer program further causes the one or more processors to:
normalize the retrieval embedding vectors, to obtain normalized vectors;
perform attention feature extraction on the normalized vectors, to obtain attention vectors; and
perform feature mapping on the attention vectors based on the target model, to obtain the first features.

18. The electronic device according to claim 17, wherein:
the normalized vectors are first normalized vectors; and
the at least one computer program further causes the one or more processors to:
concatenate the attention vectors and the retrieval embedding vectors, to obtain concatenated vectors;
normalize the concatenated vectors, to obtain second normalized vectors;
perform feed forward feature mapping on the second normalized vectors based on the target model, to obtain mapping vectors; and
concatenate the mapping vectors and the concatenated vectors, to obtain the first features.

19. The electronic device according to claim 12, wherein:
the similarities are first similarities; and
the at least one computer program further causes the one or more processors to:
obtain a sample image and sample retrieval data in a modality other than an image modality, and obtaining a similarity tag between the sample image and the sample retrieval data;
perform feature extraction on the sample retrieval data based on the target model to obtain a third feature of the sample retrieval data, and performing feature extraction on the sample image based on the target model, to obtain a fourth feature of the sample image obtained after the sample image is aligned with the sample retrieval data;
determine a second similarity between the sample image and the query data according to the third feature and the fourth feature, and determining a loss value according to the second similarity and the similarity tag; and
adjust a parameter of the target model according to the loss value.

20. A non-transitory computer-readable storage medium storing at least one computer program that, when executed by one or more processors, causes the one or more processors to:
obtain a candidate image set and query data in a plurality of modalities, the candidate image set including a plurality of candidate images;
perform feature extraction on the query data based on a target model to obtain a plurality of first features of the query data;
perform feature extraction on the candidate images based on the target model, to obtain a plurality of second features of the candidate images, each of the second features being obtained by feature extraction after the candidate images are aligned with the query data in one of the modalities;
determine a plurality of similarities each between the candidate images and the query data in one of the modalities according to the first features and the second features;
determine result image sets corresponding to a plurality of query data combinations from the candidate image set according to the similarities, the query data combinations including the query data in at least one of the modalities; and
merge the result image sets to obtain an image retrieval result.
